(19) United States
(12) Patent Application Publication
(10) Pub. No.: US 2015/0066784 A1
(43) Pub. Date: Mar. 5, 2015

(54) AUTOMATED CLICKWRAP AND BROWSEWRAP SYSTEM

(71) Applicant: Brian Powers, Westfield, IN (US)

(72) Inventor: Brian Powers, Westfield, IN (US)

(21) Appl. No.: 14/478,921

(22) Filed: Sep. 5, 2014

Related U.S. Application Data
(60) Provisional application No. 61/874,049, filed on Sep. 5, 2013.

(51) Int. Cl. G06Q 10/06; G06Q 50/18

(52) U.S. Cl. CPC G06Q 10/06; G06Q 50/18
USPC 705/311

(57) ABSTRACT

The present invention involves methods, systems, and apparatus for providing an automated clickwrap and browsewrap agreement system. In one aspect, a method includes providing an electronically securable agreement management system; allowing access to a client; associating websites with the client; storing client agreements; receiving and recording end-user identifiers; receiving and responding to client queries; and transmitting the client agreement to the client in response to the client queries. Other aspects include collecting end-user identifiers; transmitting the end-user; populating the client agreement; transmitting identifiers, queries, and agreements through an API; collecting identifiers and populating client agreements through a system module; running the system on the same server as the client website; performing statistics and analytics on stored data; and populating a client historical agreement webpage.

### CROSS-REFERENCE TO RELATED APPLICATIONS

This application claims the benefit under 35 U.S.C. §119(e) of U.S. Patent Application No. 61/874,049, entitled “Automated Clickwrap and Browsewrap System,” filed Sep. 5, 2013, which is incorporated herein by reference in its entirety.

### BACKGROUND

This specification relates to the technical field of software applications. More particularly, the present invention is in the technical field of software document management.

Electronically secured agreements, clickwrap agreements or browsewrap agreements for example, face difficulties in their implementation, validation, and enforcement. While electronically securable agreements are, by their very nature, easily modified and updated, the ease of which this is done often creates multiple versions of such agreements. This may lead to a situation of where a client using such an agreement may not know which of its end users have agreed to which versions of client's agreements. The inability to associate an end user's acceptance to a specific version may lead to impairment of enforceability of the agreement when there is a contractual dispute.

Likewise, the possibility of multiple versions of such agreements leads to various document management issues such as re-creation, re-presentation, and version tracking. Similarly, improper placement or acceptance of such agreements may render any acceptance voidable or void. As such, electronically secured agreements may prove to be problematic if not pointless if enforceability is an issue.

Additionally, the electronic nature of the securable agreements and the electronic nature of acceptance of such agreements present difficulties in validation of acceptance. For example, while such agreements may be signed by an end user's unique electronic signature they rarely are. Instead, such agreements are often agreed to by an end user's confirming action such as a click. In such cases, subsequent confirmation of acceptance is attempted by showing a received user action associated with an end user id or simply an IP address. However, the user id or IP address may subsequently prove insufficient to prove acceptance.

Further, such agreements may be complex with the existence of contractual clauses dependent upon an end user's or client's desired options. However, providing contractual flexibility opens up the issue of tracking an end user's activity to ensure that the user is abiding by his agreement. That is to say, that if an end user opts out of some client services, then there must be some way to ensure that the user may not access said services. Such enforcement of optional service access may be problematic if attempted through traditional user rights management.

### SUMMARY

This specification describes technologies relating to electronic contract management.

Embodiments of the present invention include—among other features, functions, and capabilities—systems and methods of document management of electronically presented and agreed to contracts as well as the tracking of access of contractually enabled software functions. Further, embodiments of the present invention also enable the integration of browsewrap or clickwrap agreements into new and existing websites, software, and software resources.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment containing a possible implementation of an electronically securable agreement management system.

FIG. 2 is a process flow chart associated with an embodiment of FIG. 1.

FIG. 3 is a process flow chart of a subpart of the process of FIG. 2 illustrating creation of a legal agreement on the electronically securable agreement management system.

FIG. 4 is a process flow chart of a subpart of the process of FIG. 2 illustrating modification of a legal agreement on the electronically securable agreement management system.

FIG. 5 is a process flow chart of a subpart of the process of FIG. 2 illustrating integration of the electronically securable agreement management system into a client website.

FIG. 6 is a process flow chart of a subpart of the process of FIG. 2 illustrating presentation of an agreement to an end user.

FIG. 7 is a process flow chart of a subpart of the process of FIG. 2 illustrating end users' viewing of and/or agreement to an agreement revision on the electronically securable agreement management system.

FIG. 8 is a process flow chart of a subpart of the process of FIG. 2 illustrating a process by which an end user may review an agreement's history on the electronically securable agreement management system.

FIG. 9 is a schematic diagram of an example computer system that may be used to implement the electronically securable agreement management system.

FIG. 10 depicts a screen shot of an implementation of the electronically securable agreement management system's interface to select an associated client website for management.

FIG. 11A depicts a screen shot of an implementation of the electronically securable agreement management system's interface displaying existing revisions of an agreement.

FIG. 11B depicts a screen shot of an implementation of the electronically securable agreement management system's interface displaying a new draft of an agreement.

FIG. 12 depicts a screen shot of an implementation of the electronically securable agreement management system containing an agreement editor interface.

FIG. 13 depicts a screen shot of an implementation of statistical tracking of an agreement on the electronically securable agreement management system.

FIG. 14A depicts a fixed-orientation badge that provides constructive notice to website users of legal terms and conditions via the electronically securable agreement management system.

FIG. 14B depicts an inline-orientation badge that provides constructive notice to website users of legal terms and conditions via the electronically securable agreement management system

FIG. 15A depicts an example end user signup webpage that integrates agreement retrieval from the electronically securable agreement management system.

FIG. 15B depicts an example end user signup webpage after agreement(s) retrieval from the electronically securable agreement management system but before affirmative consent from an end user.

FIG. 15C depicts an example end user signup webpage after initial affirmative consent from an end user.

FIG. 15D depicts an example end user signup webpage after terminal affirmative consent, collapsing agreement(s) and allowing signup process to proceed.

FIG. 16A depicts an example client historical agreement webpage dynamically retrieving agreements from the electronically securable agreement management system.

FIG. 16B depicts an example client historical agreement webpage with a revision deprecation warning.

Like reference numbers and designations in the various drawings indicate like elements.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an,” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not. Additionally, “generates,” “populates,” “generating,” and “populating” mean that the system 130, client, end user, and/or module may produce some event or cause some event element to be produced. For example, a client webpage may receive data to produce a badge in whole or in part to display to an end user, the client webpage may pull such data from a source other than the system (e.g., client website servers, intermediary, etc.), or the system 130 may entirely provide the badge to be produced on the webpage.

An electronic document (which for brevity will simply be referred to as a document) may, but need not, correspond to a file. A document may be stored in a portion of a file that holds other documents, in a single file dedicated to the document in question, or in multiple coordinated files.

A clickwrap agreement is a common type of agreement frequently used in conjunction with software licenses and the access to or use of materials or services on a website or downloadable product. Clickwrap agreements may be found in Internet based applications, as part of software agreements agreed to during installation processes of software applications, and in situations where the use of electronic media is being sought. Clickwrap agreements are also known as clickthrough agreements or clickwrap licenses.

A browse-wrap or browsewrap license or agreement is an agreement presented electronically covering the access to or use of materials or services on a website or downloadable product. Frequently, portions of or the entire browse-wrap agreement are implemented as hyperlinks. Unlike the clickwrap agreement, browsewrap agreements normally do not require an end user's active agreement such as clicking on an “I agree” button. Instead, an end user's use of the client's data, materials, or services is deemed acceptance of the agreement. Both clickwrap agreements and browsewrap agreements are commonly referred to by other names such as; “terms of use,” “privacy policy,” “SaaS services agreement,” “DMCA notices and registration form,” “red flag identity theft policy,” “FTC disclosures,” and the like.

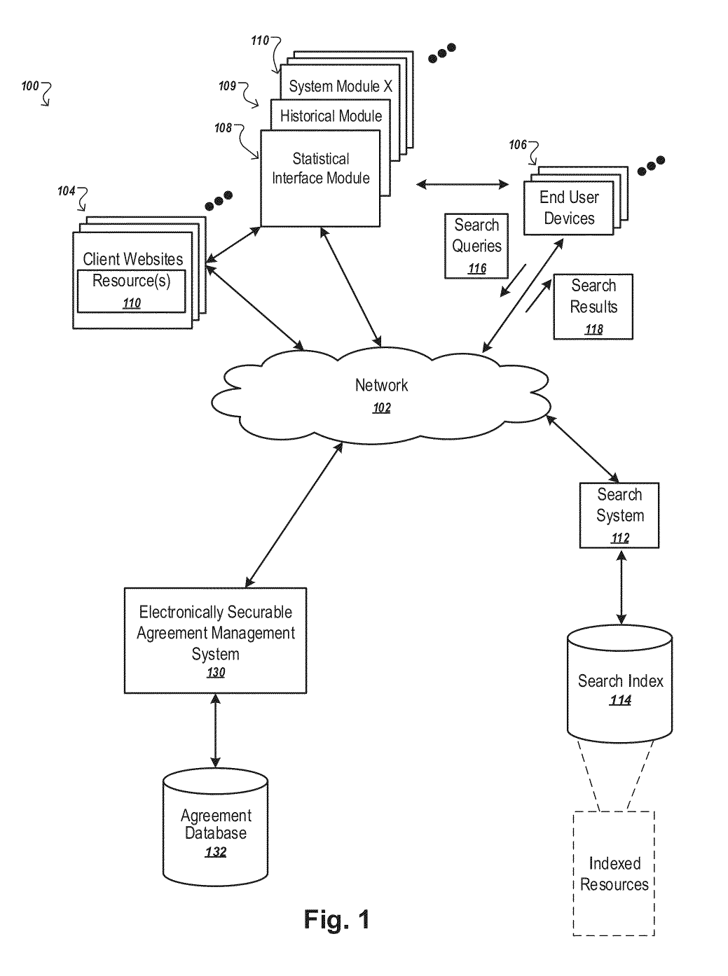

FIG. 1 is a block diagram of an example environment 100 containing a possible implementation of an electronically securable agreement management system 130 that allows monitoring end-user interaction. For example, the environment 100 includes an electronically securable agreement management system 130 that facilitates the implementation and management of electronically securable agreements. The example environment 100 also includes a network 102, such as a local area network (LAN), a wide area network (WAN), the Internet, or a combination thereof. The network 102 connects client websites 104, end user devices 106, and electronically securable agreement management system 130. The example environment 100 may potentially include many thousands of client websites 104 and/or end user devices 106.

In some implementations, client websites 104 (client apps, client services; hereinafter simply “client websites” for ease of use), end user devices 106, and the system 130 may directly intercommunicate, excluding the need for the Internet from the scope of a network 102. For example, the client websites 104, end user devices 106, and the system 130 may directly communicate over device-to-device (D2D) communication protocols (e.g., WiFi Direct, Long Term Evolution (LTE) D2D, LTE Advanced (LTE A) D2D, etc.), wireless wide area networks, and/or satellite links or the need for the network 102 entirely. In other implementations, the client websites 104, end user devices 106, and the system 130 may communicate indirectly to the exclusion of the Internet from the scope of the network 102 by communicating over wireless wide area networks and/or satellite links. Further, end user devices 106 may similarly send and receive search queries 116 and search results 118 indirectly or directly.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

The system 130 may use one or more modules to perform various functions including, but not limited to, searching, analyzing, querying, interfacing, etc. A “module” refers to a portion of a computer system and/or software program that carries out one or more specific functions and may be used alone or combined with other modules of the same system or program. For example, a module may be located on the system 130 (e.g., on the servers of the system 130, i.e., server-side module), on end user devices 106, or on an intermediary device (e.g., the client server, i.e., a client-side module; another end user device 106; a different server on the network 104; or any other machine capable of direct or indirect communication with the system 130, client websites 104, the search system 112, and/or the end user devices 106.)

Typically, modules may be coded in JAVASCRIPT (JAVASCRIPT is a registered trademark of Sun Microsystems, Inc., a Delaware corporation, located at 4150 Network Circle Santa Clara, Calif. 95054), PHP, or HTML, but may be created using any known programming language (e.g., BASIC, FORTRAN, C, C++, C#, PERL (PERL is a registered trademark of Yet Another Society DBA The Perl Foundation, a Michigan nonprofit corporation, located at 340 S. Lemon Ave. #6055)) and/or package (e.g., compressed file (e.g., zip, gzip, 7zip, RAR (RAR is a registered trademark of Alexander Roshal, an individual, located in the Russian Federation AlgoComp Ltd., Kosareva 52b-83, Chelyabinsk, Russian Federation 454106), etc.), executable, etc.).

In some implementations, the system 130 may be packaged, distributed, scripted, manually installed by a technician of the system 130, or otherwise deployed to a client server location such that the system 130 exists within the client server and/or client server network, either in whole or in part. For example, the system 130 may be scripted and/or packaged into an executable package and downloaded by a client administrator; the client administrator then installing the system 130 software package(s) onto the client server(s). Such setups may allow the system 130 to operate all system 130 operations entirely within the client server(s) and/or client network, excluding the need to interface with the system 130 provider's servers for some or all system 130 functions. Such an implementation may, for example, be used to reduce bandwidth, latency, complexity of network management, etc. In some other implementations, the client servers may facilitate only some of the system 130 functions and interface with the system 130 servers (over a network or directly) to enable those remaining functions. Still other implementations may link to the system 130 servers to obtain updates, patches, and/or other modifications to the system 130 distributions.

The system 130 software distributions may, in some implementations, be installed in a virtual environment (e.g., HYPER-V (HYPER-V is a registered trademark of Microsoft, a Washington Corporation, located at One Microsoft Way, Redmond, Wash. 98052); VIRTUALBOX (VIRTUALBOX is a registered trademark of Oracle America, Inc., a Delaware corporation, located at 500 Oracle Parkway, Redwood Shores, Calif. 94065); VMWARE (VMWARE is a registered trademark of VMWare, Inc., a Delaware corporation, located at 3401 Hillview Ave., Palo Alto, Calif. 94304), etc.).

In other implementations, the system 130 software may be installed in whole or in part on an intermediary system that is separate from the client and the system 130 servers. For example, the system 130 software may be installed by an intermediary worker, a client worker, and/or a system 130 worker onto a hosting service (e.g., AMAZON WEB SERVICES (AWS) (AWS is a registered trademark of Amazon Technologies, Inc., a Nevada corporation, located at PO Box 8102, Reno, Nev. 89507), RACKSPACE (RACKSPACE is a registered trademark of Rackspace US, Inc., a Delaware corporation, located at 1 Fanatical Place, City of Windcrest, San Antonio, Tex. 78218), etc. The client may then connect to the intermediary and/or the system 130 servers to access the system 130 functions. Such implementations may, for example, allow distributed access, redundancy, decreased latency, etc.

While FIG. 1 depicts a statistical interface module 108, a historical module 109, and a system module x 110, there may be as many or as few modules as desired. The statistical interface module 108 may represent a module that may be capable of facilitating statistical analysis and reporting of data stored on the system 130. In some implementations, stored data may be located on the system 130 itself and/or on an agreement database 132. The agreement database 132 may store, but is not limited to, information regarding the system 130, client agreements, client agreement revisions, end user viewing of client agreement revisions, end user agreement to client agreement revisions, dates and times of actions performed on or with the system 130, end user identifiers, etc. For example, the statistical interface module 108 may query and populate how many times a particular revision of a client agreement has been viewed and/or affirmatively consented to, which end users viewed and/or affirmatively consented to the revision, when such events occurred, etc.

In some implementations, the statistical interface module 108 may perform statistical operations itself with stored and/or retrieved data from the agreement database 132 (e.g., mean revision views over a time period, expected regressions for affirmative consent of a revision, comparing impression ratios between different revisions, and/or any other statistical function capable of being run programmically) and/or enable a client-side statistical application to use data stored on the agreement database 132 when the client-side statistical application performs statistical functions.

In some other implementations, this information may be populated in a dashboard-like interface (e.g., a client agreement statistics viewer 1300) on the system 130 and/or capable of interfacing with the system 130 (e.g., a client-side spreadsheet application capable of connecting to the system through the statistical interface module 108). Further implementations are discussed later in this application.

In yet another implementation, the statistical interface module 108 may also be used to discover and communicate patterns of the collected data (e.g., those stored in the agreement database 132, collected through client-defined information fields 1510, transmitted by a module, etc.) through analytics. For example, the statistical interface module 108 may parse and analyze data including, but not limited to, stored clickthrough rates, agreement view times, conversion rates, target impact, demographics (e.g., age, geographic location, income, ethnicity, lifestyle, segmentation, etc.), frequency of visitation, and frequency of viewing/affirmative consents. This analysis may be used to determine and/or predict a wide variety of metrics including patterns/trends, risks (e.g., fraud, loss of base, etc.), optimization (e.g., sizing, advertising, wording, promotion, etc.), etc. Such metrics may be useful, among other things, to predict agreement usefulness; trends of end user consent and/or apathy; and/or points of optimization among agreement revisions, format, end user experience, and presentation. In some implementations, the system 130 may contain an analytics module (not shown) that is separate from the statistical interface module 108. In other implementations, the client may interface with the system 130 and/or stored data on the agreement database 132 with a client-side application capable of statistical analysis (e.g., R statistics environment, EXCEL (EXCEL is a registered trademark of the Microsoft, a Washington corporation, located at One Microsoft Way, Redmond, Wash. 98952), etc.).

The historical module 109 may represent a module that may be capable of facilitating querying, searching, transmitting, and/or population of previous client agreement revisions. Typically, the historical module 109 interfaces the system 130 and agreement database 132 with a historical agreement webpage 1600 on a client website. The historical agreement webpage 1600 may provide an end user with some or all revisions associated with the client website and stored in the agreement database 132. Thus, for example, when an end user navigates to the historical agreement webpage 1600 and may view every version of the client webpage's Terms of Service and Privacy Policy, the historical module 109 facilitates the requests between the historical agreement webpage 1600 and/or client website and the system 130 and/or the agreement database 132.

In some implementations, the historical module 109 may collect end user identifiers to match the requesting end user with end user identifiers stored in the agreement database 132. For example, the historical module 109 may query the agreement database 132 to determine if an end user with a specific set of user identifiers has ever viewed and/or affirmatively consented to a revision of a client agreement. In some implementations, where a match has been found regarding a previous viewing and/or affirmative consent, the historical module 109 may cause the historical agreement webpage 1600 to display a list and/or notification of these previous views and/or affirmative consents. Further implementations are discussed later in this application.

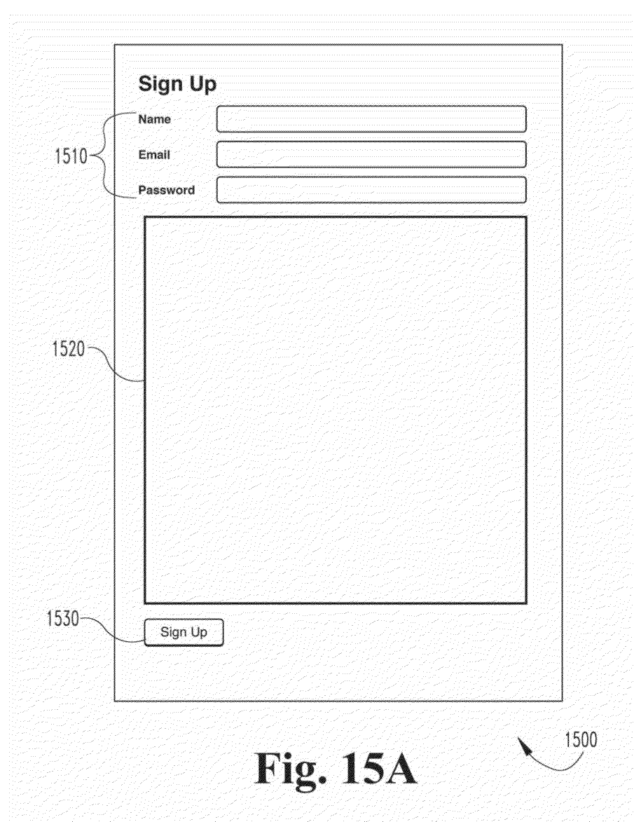

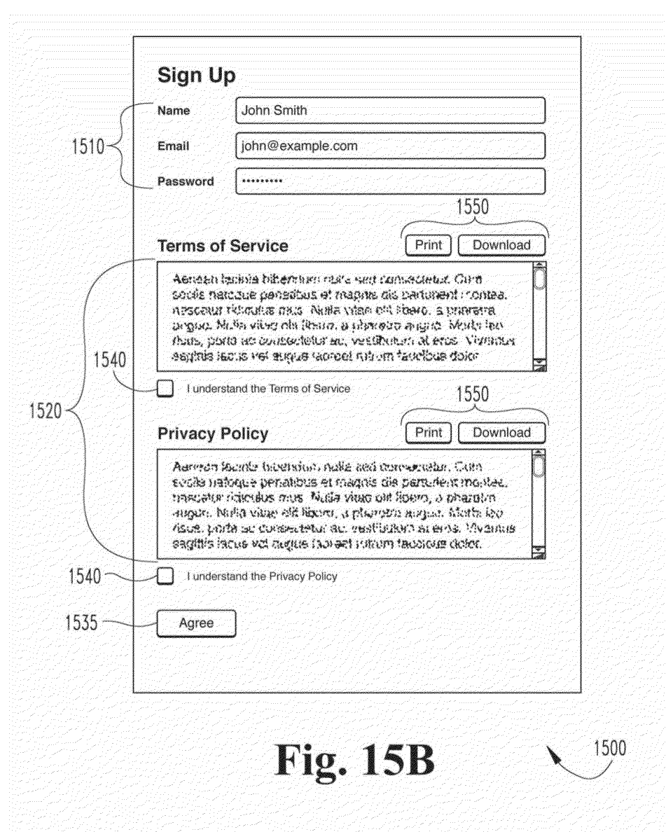

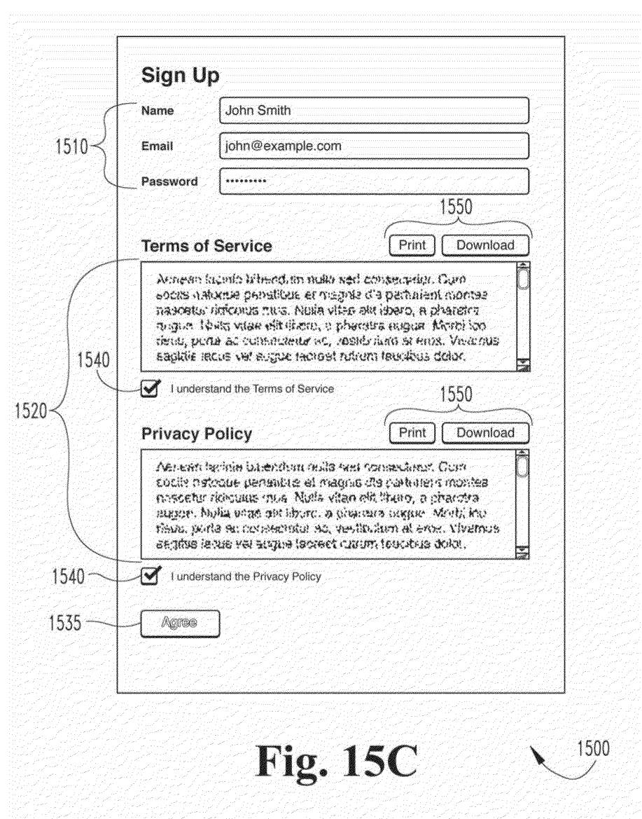

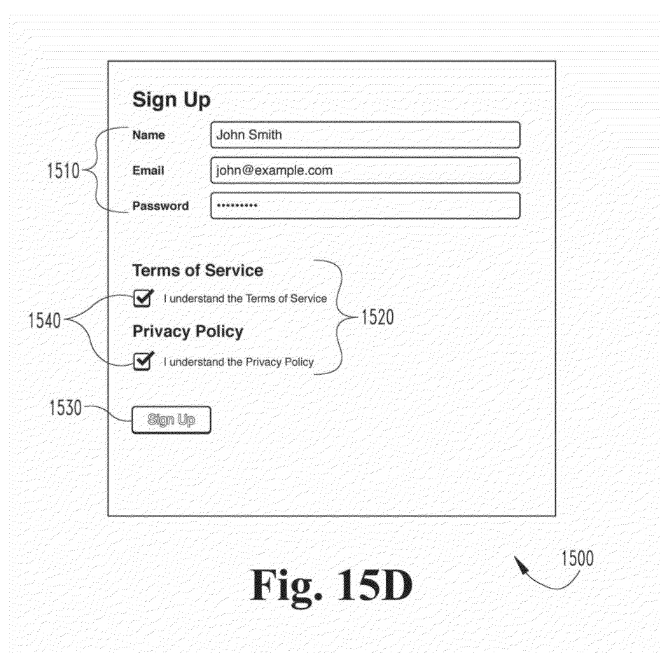

Additionally, the system module x 110 may represent a generic interfacing module to enable communication and interaction between, but not limited to, the network 102, client websites 104, end user devices 106, the search system 112, and/or the electronically securable agreement management system 130. For example, the system module x 110 may facilitate an end user's request for the current version of a client website's Terms of Service agreement, populate all relevant client agreements on an end use signup page (e.g., as shown in FIGS. 15A-15D), generate badges, and/or any other task to be accomplished by a module. Further implementations are discussed later in this application.

Client websites 104 are one or more resources 110 associated with a domain name and/or a network address and hosted by one or more servers. An example client website 104 is a collection of web pages formatted in hypertext markup language (HTML) that may contain text, images, multimedia content, and programming elements, such as scripts. Each client website 104 is maintained by a publisher, which is an entity that controls, manages, and/or owns the client website 104.

Resource 110 is any data that may be provided over the network 102. For example, resources 110 may be data of a browsewrap agreement. Resource 110 has a network address (e.g., a uniform resource locator) by which resource 110 may be accessed. Resources 110 include HTML pages, word processing documents, and portable document format (PDF) documents, images, video, and feed sources, to name only a few. Resources 110 may include content, such as words, phrases, software and applications, images and sounds, that may include embedded information (such as meta-information in hyperlinks) and/or embedded instructions (such as JAVASCIPT scripts). Units of content (e.g., data files, scripts, content files, or other digital data) that are presented in (or with) resources are referred to as content items.

End user devices 106 are electronic devices that are under control of an end user and are capable of requesting and receiving resources over the network 102. Example end user devices 106 include personal computers, mobile communication devices (e.g., smartphones, PDAs, etc.), and other devices that may send and receive data over the network 102. End user devices 106 typically include a user application, such as a web browser, to facilitate the sending and receiving of data over the network 102.

In some implementations, end user devices 106 may interact with each other directly or indirectly, excluding the network 102. For example, end user devices 106 may rely entirely on the system 130 or may directly communicate with other end user devices.

End user devices 106 may request resources 110 from client website 104. In turn, data representing the resource 110 may be provided to the end user device 106 for presentation by the end user device 106. The data representing the resource 110 may also include data specifying a portion of the resource or a portion of a user display (e.g., a small search text box or a presentation location of a pop-up window) in which advertisements may be presented or third party search tools may be presented.

To facilitate searching of these resources 110, the environment 100 may include search system 112 that identifies the resources 110 by crawling and indexing the resources 110 provided by the publishers on the websites 104. Data about the resources 110 may be indexed based on the resource 110 to which the data corresponds. The indexed and, optionally, cached copies of the resources 110 are stored in search index 114.

End user devices 106 may submit search queries 116 to the search system 112 over the network 102. In response, the search system 112 accesses the search index 114 to identify resources 110 that are relevant to the search query 116. The search system 112 identifies the resources 110 in the form of search results 118 and returns the search results 118 to the end user devices 106 in search results pages. Search result 118 is data generated by the search system 112 that identifies resource 110 that is responsive to a particular search query, and includes a link to the resource 110. An example search result 118 may include a web page title, a snippet of text or a portion of an image extracted from the web page, and the URL of the web page.

In some implementations, the electronically securable agreement management system 130 may also interact with search systems 112 and advertisement systems to allow for up-to-date clickwrap and/or browsewrap agreements to be presented along with various targeted advertisements and/or search results. For example, some advertisements such as pharmaceutical advertisements require or are likely to require various disclosures and agreements before presenting the advertisement to the user.

In response to query 116, the user may be provided search results 118 that have been identified as responsive to the search query (i.e., have at least a minimum threshold relevance to the search query, for example, based on cosine similarity measures or clustering techniques). The user may then select one or more of the search results 118 to request presentation of a web page or other resource 110 that is referenced by a URL associated with the search result. Similarly, end user devices 106 may request resources 110 from the client website 104. Further, the use or access of resource 110 may initiate the delivery of additional resources 110. For example, a browsewrap agreement may be the resource 100 that was requested, accompany resource 110, or be part of resource 110.

Electronically securable agreement management system 130 is also depicted in FIG. 1. In some implementations, the electronically securable agreement management system 130 comprises a dashboard-like user interface (management interface) enabling a client to upload or download the client's agreements, contract clauses, and to manage the client's resources 110 relevant to the client's agreements or contract clauses. For example, the electronically securable agreement management system 130 may also enable a client to associate frequently asked questions lists (FAQ's) and common terms explained lists with the client's agreements or contract clauses. Alternatively, the dashboard allows users to easily manage the versions of their agreements. In some implementations, the dashboard of electronically securable agreement management system 130 further comprises a document wizard system enabling users to select basic agreements and customize them to their specific needs. For example, a client could use the electronically securable agreement management system 130 to create a clickwrap agreement specifically suited to the client website 104.

In some implementations, the returned web page 104 or resource 110 may include code intended to execute upon the end user device 106. The code, upon executing upon the end user device 106, may initiate communication with the electronically securable agreement management system 130 and transfer agreement information. For example, as part of downloadable content, a client could include a shrinkwrap agreement. This shrinkwrap agreement could contain code that once agreed to by the user, could send agreement information to the electronically securable agreement management system 130. Similarly, a clickwrap agreement could also contain or be wrapped in code for execution upon the end user device 106. Examples of information that may be conveyed include but are not limited to unique identifiers, activation codes, software identification information, end user device information, user information, dates of agreement acceptance, and the like. Further, some implementations of the electronically securable agreement management system 130 enable data analysis of the data and metadata. For example, some implementations of the electronically securable agreement management system 130 enable the data analysis of the number of successful agreements for a given revision of an agreement.

In addition to providing a dashboard enabling a client to manage his electronically securable agreements, the electronically securable agreement management system 130 may also maintain the versions of the electronically securable agreements, dates, and contents of revisions to the electronically securable agreements, dates, and agreement information for agreed to electronically securable agreements, and the like. Further, the electronically securable agreement management system 130 may also import or export documents, agreement information, version information, and the like into a number of formats. For example, the versions of an electronically securable agreement may be exported in a PDF format.

In some implementations of the electronically securable agreement management system 130, user agreement information may be anonymized to protect the identity of the agreeing user. For example, user identifiers may be removed from the user agreement information data with only a one-way encryption enabling the electronically securable agreement management system 130 to positively identify those that have agreed to a specific agreement. The one-way encryption is used to prevent non-electronically securable agreement management system identification of those users that have agreed to agreements. As an example using a different approach to anonymize users, the user agreement information may be associated with a hash value of the user agreement information to anonymize the user agreement information.

When the electronically securable agreement management system 130 and the search system 112 are operated by a same entity, user interaction data may be obtained by the electronically securable agreement management system 130 in a manner similar to that described above. For example, the electronically securable agreement management system 130 may return a selection of electronically securable agreements associated with the resources 110 associated with the search results. In this way, an end user could comparison shop or product compare by comparing the shrinkwrap or clickwrap agreements associated with resources 110 associated with the user's search terms.

When a client utilizes the electronically securable agreement management system 130, the client is supplied with code and/or graphics depicting a badge of authenticity. Typically, the client may be supplied with the code and/or graphics from the system 130 through a physical media containing the code and/or graphics (e.g., floppy disks, compact disks (CDs), digital video disks (DVDs), flash memory/Universal Serial Bus drives, hard drives, etc.), a downloadable software package (e.g., an executable file, a compressible archive, etc.) produced by and/or for the provider of the system 130, through a data link to a repository associated with the system 130, or through any other method of transferring the code and/or graphics—directly or indirectly—from the system 130 to the client. Typically, the badge may be data that generates a visible icon and/or banner on a display of a client website 104 being viewed by an end user. For example, the generated badge may be a blue rectangle located at the bottom-center of the display and emblazoned with the words “Legal Terms.” Further example badges are described later in the application.

In some implementations, the badge may also be tracked by the system 130 to provide additional information about the end user's notice on the client website. For example, the client may send user identifiers to the system 130 to record when the badge is displayed to the end user, when the end user views a client agreement, and/or when the end user affirmatively consents to the client agreement. Badge information that is sent to the system 130 may include, but is not limited to, the manner in which the badge was displayed (e.g., inline, fixed, location on the client website/webpage, etc.); display characteristics of the badge (e.g., color, size, etc.); when the badge was displayed (e.g., when end user first loaded website, only when end user viewed specific webpages, etc.); how long the badge was displayed (e.g., all the time, for a set amount of time, for a variable amount of time, etc.), and/or the mechanism by which the badge was generated (e.g., directly encoded into the website/webpage, with a client-side module, with a server-side module, with an intermediary module, etc.).

In some other implementations, the badge may provide assurance to users that their agreement to a browsewrap or clickwrap agreement will be recorded and tracked. Additionally, in some implementations, the electronically securable agreement management system 130 also allows users to review a document history of a browsewrap or clickwrap agreement. For example, an end user may review the history of a browsewrap agreement before agreeing to it. That way, an end user could review the history of the changes of an agreement to help get a feel as to what areas of the agreement have proven the most difficult for previous users to understand and adhere to.

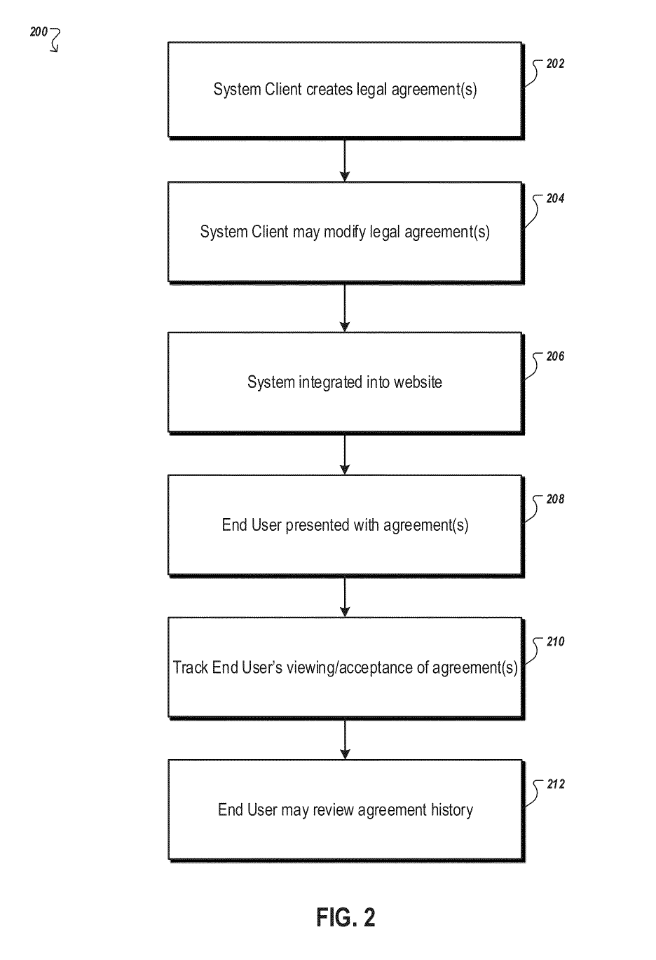

FIGS. 2-8 illustrate process flows for some embodiments of the present novel technology (e.g., an embodiment of FIG. 1). With regard to FIGS. 2-8, a typical transaction would include the electronically securable agreement management system 130, where client agreements are stored; a client (e.g., Company A's server) that has one or more websites (e.g., CompanyA.com, CompanyA.org, etc.) upon which client agreements on the electronically securable agreement management 130 are associated; and an end user, who uses an end user device 106 to connect to the client website 104 and to view the client agreements. The client website 104 may have a single client agreement associated with it, or it may have a near infinite number of client agreements associated with it; and the end user may be presented with a single client agreement or a near infinite number of client agreements. Further, in some instances, the end user may visit a client website 104 that is connected to the system and never be presented with a client agreement.

FIG. 2 describes one embodiment of an overall process flow 200 for using the system 130, typically including the steps of ‘System Client creates legal agreement(s)’ 202; ‘System Client may modify legal agreement(s)’ 204; ‘System integrated into website’ 206; ‘End User presented with agreement(s)’ 208; ‘Track End User's viewing/acceptance of agreement(s)’ 210; and ‘End User may review agreement history’ 212.

The ‘System Client creates legal agreement(s)’ 202 step may typically be performed by a client through one or more management interfaces (e.g., associated with the system 130 that may, for example, be available through a browser, through a client-side application with a connection to a system-side server, or any other appropriate mechanism of interfacing with the system 130. For example, the client may go to www.managementsystem.com, enter his or her credentials, select the website that he or she wishes to have a new client agreement for, and follow a guided routine to create the new client agreement on the server. In another implementation, the client may create a new client agreement on his or her computer, upload it to the system, and the system 130 may manually or automatically review and/or publish the new client agreement revision. This step is further described later in this application.

Additionally, the ‘System Client may modify legal agreement(s)’ 204 step may typically be performed in many of the same ways as the above-described step. For example, the client may amend a client agreement through an online interface with a guided process or through a client-side submission method. The system 130 may, in some implementations, automatically parse the uploaded client agreement text, perform a differential analysis between the old client agreement and the new client agreement, and create a differential-view document (e.g., a redline, a time-delayed interchange image that displays each version for two seconds each in a loop, or a mouse-over image that changes from the old revision to the new revision when the end user mouses-over the client agreement.) Such a differential view may, for example, be implemented in a historical agreement webpage 1600 (agreement history webpage; described later in this application). This step is further described later in this application.

The ‘System integrated into website’ 206 step may typically be performed by the client adding a module (e.g., statistical interface module 108, historical module 109, and/or system module x 110) into his or her client website coding. For example, the client may add a client-side module using HTML, PHP, JAVASCRIPT, or any other mechanism for programmatically interfacing between the client website 104 and servers associated with the system 130. In some implementations, the client of the system 130 may supply the client-side software for integration, while in other implementations the client may provide their own software for integration. Typically, communication from the integrated component to the system 130 is accomplished through an application programming interface (API). This step is further described later in this application.

Further, the ‘End User presented with agreement(s)’ 208 step may typically be performed by the above-integrated software component, which interfaces between the client website 104 and servers associated with the system 130. Again, this is typically accomplished through the use of an API. Once the end user browses to a webpage that requests client agreement information (e.g., the end user browses to the “Legal Terms and Conditions” webpage of a client website 104); the client-side integration software makes a programmatic request call to the system 130 for a specific client agreement (e.g., the current revision of Company A's Terms and Conditions); the system 130 processes the request, retrieving the requested client agreement if possible; and the system 130 sends the retrieved client agreement back to the client, where it is populated on the webpage and presented to the end user. This step is further described later in this application.

The ‘Track End User's viewing/acceptance of agreement(s)’ 210 step may typically be performed by the client-side integration application and/or through a separate tracking software module (e.g., the statistical interface module 108, historical module 109, and/or system module x 110) that interfaces with the system 130. When the end user browses to a webpage and is presented with a retrieved client agreement, the tracking software (in whatever form) may collect end user information and transmit that collected information to servers associated with the system 130, along with the identification of the specific client agreement revision and an indication that the end user has viewed said revision. The system 130 then stores this information.

In some implementations, if the end user also provides affirmative consent to the presented client agreement, user information may be again collected and sent to the servers associated with the system 130, along with the client agreement revision and an indication that the client agreement has been affirmatively agreed to by that end user. The system 130 may, in some embodiments, include a management interface (such as the client agreement statistics viewer 1300, described later in this application) in which viewing and client agreement statistics may, among other things, be viewed, sorted, analyzed, and/or exported. This step is further described later in this application.

Finally, the ‘End User may review agreement history’ 212 step may typically be performed when an end user browses to a client historical agreement webpage 1600 that is configured to dynamically, list, request, and retrieve some or all previous revisions of a client's agreement(s) stored on the system 130. For example, where Company A is the client, an end user may wish to view every revision of Company A's Terms of Service from inception to the current, most recent revision. In some implementations, when the end user browses to the agreement history webpage 1600 configured to conduct this retrieval and population, an integrated software interface may request and retrieve every revision of the Terms of Service agreement that is stored on the system 130. In another implementation, a software interface may only request a listing of the client agreement revisions, only retrieving the full text of the revision when the end user selects that particular revision. In some further implementations, the agreement history webpage 1600 and/or the system 130 may provide a differential view to compare client agreement revisions (e.g., in a redline, time interchange, or mouseover implementation, as described above). This step is further described later in this application.

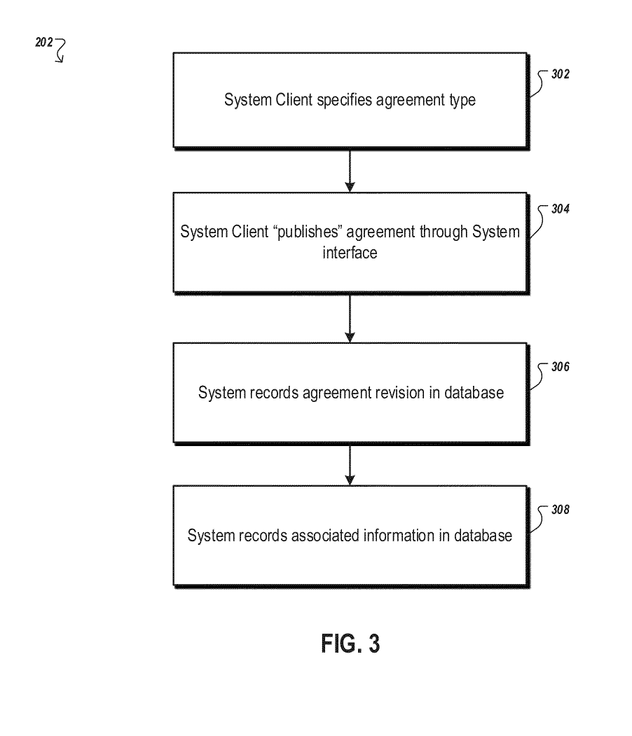

FIG. 3 describes the subparts of the ‘System Client creates legal agreement(s)’ 202 step, typically including the substeps of ‘System Client specifies agreement type’ 302; ‘System Client “publishes” agreement through System interface’ 304; ‘System records agreement revision in database’ 306; and ‘System records associated information in database’ 308.

The ‘System Client specifies agreement type’ 302 step may typically be performed by a client by selecting from a list of client agreement types and functions. For example, the client may log in to the system 130, create a new agreement through the agreement documents interface 1100 and/or the agreement editor interface 1200, and then specify an client agreement function (e.g., clickwrap, browsewrap, etc.) with an agreement function selector 1240 and/or an client agreement type (e.g., Terms of Service, Privacy Policy, etc.) with an agreement type selector 1250.

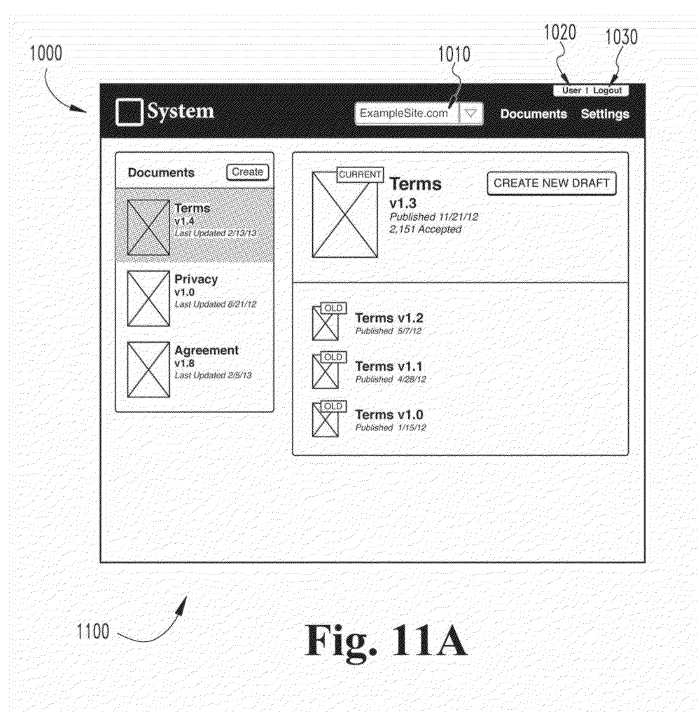

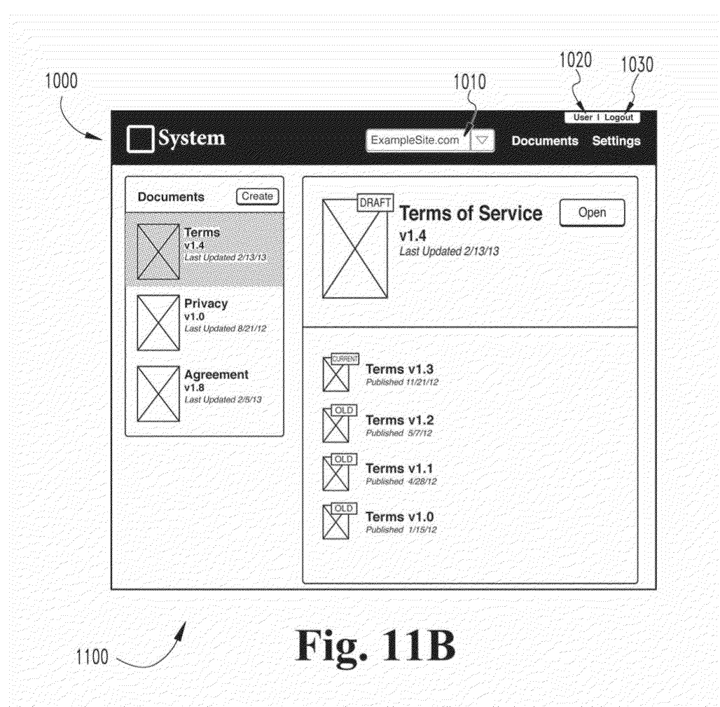

In some implementations, such as when creating a new draft revision of an existing client agreement (e.g., as shown in FIG. 11B), such properties may be inherited automatically and/or manually approved by a client. In another implementation, document properties may be embedded or set within a document, and the system 130 may parse the document properties to populate the client agreement type properties within the system 130. In a further implementation, the system 130 may also have preset client agreement types that may be selected by the client when creating an initial client agreement or may be automatically created upon a client defining a client website 104 in the system 130.

The ‘System Client “publishes” agreement through System interface’ 304 step may typically be performed by the client through an agreement documents interface 1100 and/or agreement editor interface 1200. For example, a client may press a button, link, or other input mechanism in the agreement documents interface 1100 and/or the agreement editor interface 1200 (e.g., through editor publication options 1260). In some other examples, the system 130 may automatically publish agreements uploaded by the client to the system 130. When the client “publishes” an agreement (through whatever mechanism), the agreement is set to become the current agreement for the associated client website 104, and when an end user's browsing causes a client's webpage to request the current agreement revision, the system 130 returns the published current agreement.

The ‘System records agreement revision in database’ 306 step may typically be performed by the system 130. After a client triggers an above-described publication command, the system 130 records the entire published agreement revision's text into one or more databases associated with the system 130. For example, after a client modifies the current agreement revision, in whole or in part, the system 130 saves the entire agreement.

In another implementation, the system 130 may implement differential recordation of the revisions. For example, if the newest revision merely changes the address of Company A, then the system 130 would only record the deletion of the old address and the addition of the new address, while referencing the previous revision(s) for the remainder of the agreement's text. Conversely, if no previous revision exists or the agreement entirely changes from a previous revision, then the system 130 would save the entirety of the agreement in one or more databases associated with the system 130. In this way, the system 130 may deduplicate redundant text of the new revision compared to the old revision, thus saving only the new additions to the revision instead of the entire text of the new revision. This may be implemented, for example, to save space, reduce bandwidth usage, to enable easy differential views of the changes, or for any other deduplication or differential recordation usage case.

Finally, the ‘System records associated information in database’ 308 step may also typically be performed by the system 130. Typically, the system 130 parses the document properties contained or embedded within a document and/or the document properties set by a client (e.g., through document information prompts 1210). For example, the document properties may include, but are not limited to, the document name, the document version, the agreement function, the agreement type, the agreement author, the date and time created/modified/uploaded, the associated client website 104, and/or an error-correction checksum and/or hash value (e.g., cyclical redundancy check, message digest, secure hash algorithm, etc.). The system 130 may store these properties, along with an association to the agreement revision text, for purposes including, but not limited to, searching, analysis, retrieval, deduplication, etc.

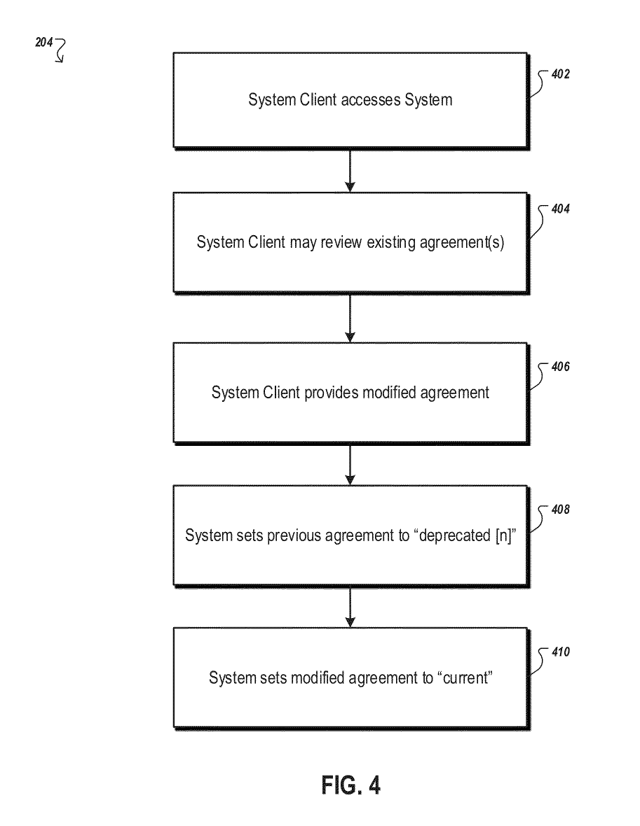

FIG. 4 describes the subparts of the ‘System Client may modify legal agreement(s)’ 204 step, typically including the substeps of ‘System Client accesses System’ 402; ‘System Client may review existing agreement(s)’ 404; ‘System Client provides modified agreement’ 408; ‘System sets previous agreement to “deprecated [n]”’ 410; and ‘System sets modified agreement to “current”’ 412.

The ‘System Client accesses System’ 402 step may typically be performed by the client through a web browser, a client-side software application, and/or command-line interface. For example, a client may navigate to www.systemanagement.com and log in to the system 130. In another implementation, the client may use a client-side software application installed on the client's machine that interfaces with the system 130. By whatever mechanism, the client gains access to the system 130 to view and modify existing agreements.

The ‘System Client may review existing agreement(s)’ 404 step may typically be performed by the client after gaining access to the system 130. For example, the client may view in an Internet browser a listing of agreements associated with his or her client website 104 and/or have a listing appear on a client-side software program. The client may, in some implementations, view every revision of a client agreement or may select to view just the most recent client agreement revision.

The ‘System Client provides modified agreement’ 408 step may typically be performed by the client once he or she has reviewed an existing agreement and decided that modifications will be made to the existing agreement, resulting in a new revision of the agreement. The client may provide the modified agreement by making edits to the existing agreement revision through an editor (e.g., agreement editor interface 1200), uploading a modified agreement revision to the system 130, or through any other mechanism of providing the modified agreement revision to the system 130. The system 130 may simply accept the revision, store the revision and associated information, provide confirmation of receipt of the modified revision to the client, list the changes between the previous revision and the new revision, and/or automatically publish the revision.

The ‘System sets previous agreement to “deprecated [n]”’ 410 step may typically be performed by the system 130 after the client has provided a modified agreement revision to the system 130. The system 130 then sets the current status of the previous revision to “deprecated [n]”, wherein the “[n]” represents the revision number. For example, if a client provides a modified revision of Terms of Service revision 1.3 as Terms of Service revision 1.4, the system 130 would set Terms of Service revision 1.3's status in the system 130 (e.g., in one or more databases associated with the system 130) as “deprecated 1.3”. Setting the revision as such allows the system 130 to retrieve efficiently the most recent version of a client agreement or historical agreements and provides for enhanced searching, tracking, and analysis capabilities.

Finally, the ‘System sets modified agreement to “current”’ 412 step may typically be performed by the system 130 after the client provides a modified agreement and the most recent previous revision was set to “deprecated [n]”; however, the system 130 may perform the instant step first if that is desired. In the above example, the client's provided Terms of Service revision 1.4 would be set to a status of “current” on the system 130 (e.g., in one or more databases associated with the system 130). Setting this value may, for example, allow a module or client-side software application to query the system 130 for any document associated with the client website 104 with a value of “current”, as the other identification schemes may fail to return the desired revision for a multitude of reasons. For example, perhaps a client reverted to a previous revision due to public criticism or an error in the agreement language, which would mean retrieving the highest number revision or the most recent revision would not provide the client's desired agreement revision.

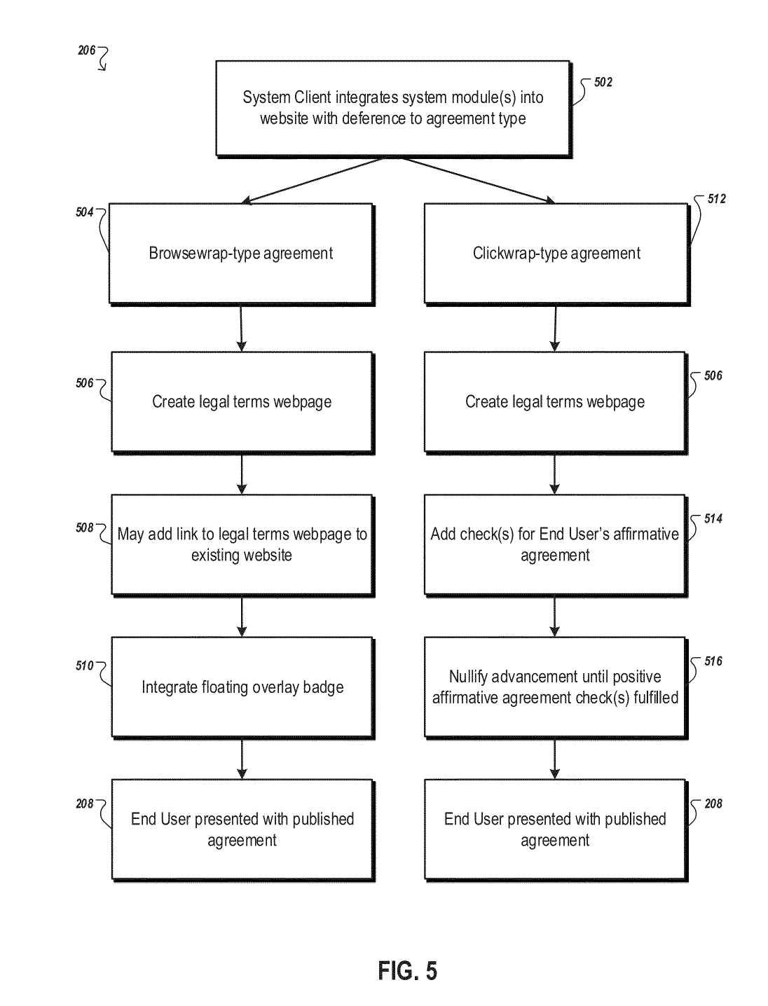

FIG. 5 describes the subparts of the ‘System integrated into website’ 206 step, typically including the substeps of ‘System Client integrates system module(s) into website with deference to agreement type’ 502; ‘Browsewrap-type agreement’ 504; ‘Create legal terms webpage’ 506; ‘May add link to legal terms webpage to existing website’ 508; ‘Integrate floating overlay badge’ 510; ‘Clickwrap-type agreement’ 512; ‘Add check(s) for End User's affirmative agreement’ 514; ‘Nullify advancement until positive affirmative agreement check(s) fulfilled’ 516; and ‘End User presented with published agreement’ 208.

The steps of ‘Browsewrap-type agreement’ 504 and ‘Clickwrap-type agreement’ 512 serve to direct the process flow depending on which option type the client wishes to use on the client website 104. Clickwrap- and browsewrap-type agreements are described elsewhere in this application.

The ‘System Client integrates system module(s) into website with deference to agreement type’ 502 step may typically be performed by a client adding a module (statistical interface module 108, historical module 109, and/or system module x 110) into his or her client website coding. For example, the client may add a client-side module using HTML, PHP, JAVASCRIPT, or any other mechanism for programmatically interfacing between the client website 104 and the system 130 servers. In some implementations, the provider of the system 130 may supply the client-side software for integration, while in other implementations the client may provide their own software for integration.

Typically, communication from the integrated component to the system 130 is accomplished through an application programming interface (API). When integrating the module(s) into the website, deference is given to the type of agreement that is sought to be used on the website. For example, if the client wishes to use a browsewrap-type client agreement, specific steps may be taken to provide sufficient constructive notice to a website end user of the client's legal terms and conditions. Conversely, if the client wishes to enforce a clickwrap-type of client agreement on the website, the system module may perform different actions (e.g., requiring end user to fill out a form or affirmatively consent to an client agreement by clicking checkboxes, singing the end user's name, etc.) that would otherwise be unnecessary for a browsewrap-type of client agreement. A client may also wish to integrate multiple client agreement schemes for the entire website or for subparts of a website and therefore may configure the module(s) to work with multiple client agreement types (e.g., both browsewrap- and clickwrap-type client agreements).

The ‘Create legal terms webpage’ 506 step may typically be performed by a client to display the client website 104's effective client agreements. Legal terms webpages may be created with regard to clickwrap-type client agreements, where an end user would have to affirmatively consent to the text of each populated client agreement, or to browsewrap-type client agreements, where an end user could navigate to the legal terms webpage by clicking a link or following a constructive notice indicator. This webpage may typically be created using existing programming languages (e.g., HTML, CSS, PHP, JAVASCRIPT, etc.). In some implementations, the legal terms webpage may be located outside of the client website 104 (e.g., at a third-party intermediary website) or dynamically created following a pre-established design scheme. The legal terms webpage allows an end user to view client agreements that the end user is subject to while browsing the client website 104.

The ‘May add link to legal terms webpage to existing website’ 508 step may typically be performed by the client when the client wishes to implement a browse-wrap type client agreement. Similar to above, the client may simply add a link through existing mechanism of programming (e.g., HTML, PHP, etc.) or with a dynamic generation scheme. The link allows an end user to navigate to the legal terms webpage described above. In some implementations, there may be more than one link; the link may appear on every webpage of the client website 104; the link may be a hyperlink in plain English; and/or the link may be associated with an image or icon, wherein clicking on the image or icon navigates an individual to the legal terms webpage.

The ‘Integrate floating overlay badge’ 510 step may typically be performed by the client or by a module. The floating overlay badge acts to provide constructive notice to the end user browsing a client website 104 that the end user is subject to the website's legal terms and conditions. In some implementations, the floating overlay badge may be in a fixed orientation as a fixed badge 1420 or an inline orientation as an inline badge 1430 (both described later in application). The badge may be presented on any display that the end user is using to view the client website 104, including, but not limited to, a user device 106 having a desktop display 1400 or a mobile display 1410 (both described later in application). In some implementations, the badge may be realized by the module(s) (e.g., system module x 110) integrated into a client website 104, while in other implementations the badge may be realized separate from the modules(s).

The ‘Add check(s) for End User's affirmative agreement’ 514 may typically be performed by a module or client website code. These checks typically may be in the form of checkboxes located in proximity to a client agreement (as shown in FIGS. 15B-15C), but may also appear in any form that is conducive to receiving an affirmative consent verification. For example, a website may contain a textbox located near an agreement requiring the end user to consent by typing “I Agree” or “Yes”. In some implementations, additional checks may be used to verify an end user's affirmative consent. For example, a form may additionally require an end user to solve a word or number problem by typing in their answer or to retype a challenge-response test (e.g., a CAPTCHA).

The ‘Nullify advancement until positive affirmative agreement check(s) fulfilled’ 516 step may typically be performed by a module or webpage code established by a client. The module or code deactivates advancement of a signup or login process until the end user completes the above-described affirmative consent checks. For example, a form may include a button stating “Continue” or “Agree” that is inactive until the affirmative consent check requirement is met. In some implementations, the process may indicate the deactivation of a component (e.g., the “Continue” or “Agree” button) by providing one or more stimuli (e.g., coloration of the button, auditory alters of rejection, or tactile feedback).

If and when the above-described affirmative consent check requirement is met, the module or code activates the advancement component (e.g., a button or link). In some implementations, the advancement component may not appear on the webpage until the affirmative consent checks are complete, while in another implementation completion of the affirmative consent checks may automatically trigger advancement without further interaction with an advancement component.

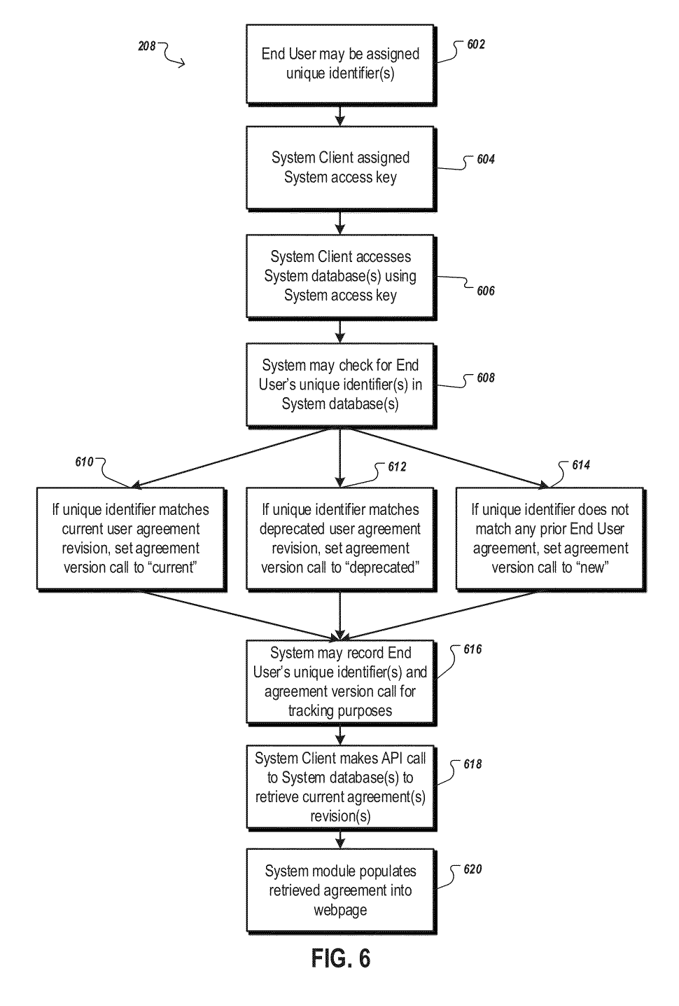

The ‘End User presented with published agreement’ 208 step is described in detail later in this application with respect to FIG. 6.

In some implementations, clients may choose to implement some or all of each of the above-described characteristics. For example, a clickwrap-type agreement may also place a badge and legal terms webpage on the client webpage. In some further examples, the module(s) (e.g., the system module x 110) may query the system 130 for agreement-type information stored on the system 130 in association with the requestor client website 104 and automatically create and/or populate components on the client website 104. For example, the module integrated on the Company A website may query the system 130 and the system 130 may indicate that the client website 104 has both a clickwrap-type introduction screen for website registrations and a browsewrap-type client agreement for a weblog (blog) on the client website 104. The module may then create a legal terms webpage populated with the client agreement(s), a badge to display to the user, and a form for the clickwrap-type client agreement using pre-established format and/or style schemes.

FIG. 6 describes the subparts of the ‘End User presented with agreement(s)’ 208 step, typically including the substeps of ‘End User may be assigned unique identifier(s)’ 602; ‘System Client assigned System access key’ 604; ‘System Client accesses System database(s) using System access key’ 606; ‘System may check for End User's unique identifier(s) in System database(s)’ 608; ‘If unique identifier matches current user agreement revision, set agreement version call to “current”’ 610; ‘If unique identifier matches deprecated user agreement revision, set agreement version call to “deprecated”’ 612; ‘If unique identifier does not match any prior End User agreement, set agreement version call to “new”’ 614; ‘System may record End User's unique identifier(s) and agreement version call for tracking purposes’ 616; ‘System Client makes API call to System database(s) to retrieve current agreement(s) revision(s)’ 618; and ‘System module populates retrieved agreement into webpage’ 620.

The ‘End User may be assigned unique identifier(s)’ 602 step may typically be performed by the client or a module. Typically, unique identifier(s) are numeric or alphanumeric strings and/or values that are previously recorded. Unique identifier(s) may, in some implementations, be derived from an algorithm using various environment factors as inputs. For example, the first eight digits may be the current date; the next four digits may be the current time, the next four may be the end user's trailing four Internet Protocol version 4 (IPv4) or Internet Protocol version 6 (IPv6) digits, etc. In some other implementations, the unique identifier may, but is not limited to, identify an end user between multiple sessions at multiple locations or track how many discrete times a certain IP address accesses a webpage. Because further information may be recorded when the end user views and/or agrees to an client agreement, the unique identifier may not be a necessity, but it may help during certain functions (e.g., search, analysis, etc.).

The ‘System Client assigned System access key’ 604 step may typically be performed by the system 130. The assigned system access key may, but is not limited to, be a unique code, a rolling code, a code given to every client, or a code given to every client of a certain client subgroup. Typically, the system access key provides a mechanism for granting access to system 130, may or may not be unique, may be one or more elements, and is used in context to identify a client or client website 104.

The ‘System Client accesses System database(s) using System access key’ 606 step may typically be performed by a module or a client server through an interface to the system 130. Typically, the interface to the system 130 (e.g., module, client-side software application, etc.) may use the assigned system access key to connect to the system 130 through an API. The client may, in some implementations, access the system 130 directly, while in other implementations the client may connect to the system 130 indirectly.

The ‘System may check for End User's unique identifier(s) in System database(s)’ 608 step may typically be performed by the system 130. In some implementations, the system 130 may recognize, authenticate, and/or record each access from a client webpage. For example, a client may view the number of times a particular unique identifier has agreed to and/or viewed client agreements. In some further implementations, these access records may be used for analysis, search, or any other related function.

The ‘If unique identifier matches current user agreement revision, set agreement version call to “current”’ 610; ‘If unique identifier matches deprecated user agreement revision, set agreement version call to “deprecated”’ 612; the ‘If unique identifier does not match any prior End User agreement, set agreement version call to “new”’ 614; and the ‘System may record End User's unique identifier(s) and agreement version call for tracking purposes’ 616 steps may typically be performed by the system 130. Typically, setting this value may allow, but is not limited to, tracking and analysis of consent to client agreements by end users; new end user impressions; and overall end user consent trends. For example, if end users consistently agree to each new client agreement revision, but twenty percent suddenly do not agree to a revised client agreement, the client agreement revision may be flagged for review.

The ‘System Client makes API call to System database(s) to retrieve current agreement(s) revision(s)’ 618 step may typically be performed by the client server or a module. Typically, the API call contains the above-described system access key; however, access may be granted through other authentication components. For example, the system 130 may automatically process any requests from a certain static IP address that Company A has assigned. Alternatively, the system 130 may automatically allow pass-through authentication where a client uses a certificate, token, or other authentication method. Typically, the API call includes the client website 104 and the client agreement(s) to be retrieved. In some implementations, the API call may also include the revision(s) to be retrieved.

Finally, the ‘System module populates retrieved agreement into webpage’ 620 step may typically be performed by a module (e.g., system module x 110, etc.). Typically, the system 130 then sends the requested revision(s) back to the module after the client or module makes a request to the system 130, the system 130 records end user information, and the system 130 retrieves the requested agreement revision(s). The module then populates the retrieved client agreement revision(s) onto the webpage that initiated the request.

In some implementations, population occurs in a single window, while in other implementations the population may occur in multiple windows. In some further implementations, population is dynamic and the module may populate a cached client agreement version only upon the end user's selection a specific revision. For example, if an end user browses to an agreement history webpage 1600, the module may request and cache the client website 104's Terms of Service, Privacy Policy, and Warranty agreements (each which may have multiple revisions), but the end user may view each specific revision upon clicking on a corresponding selection.

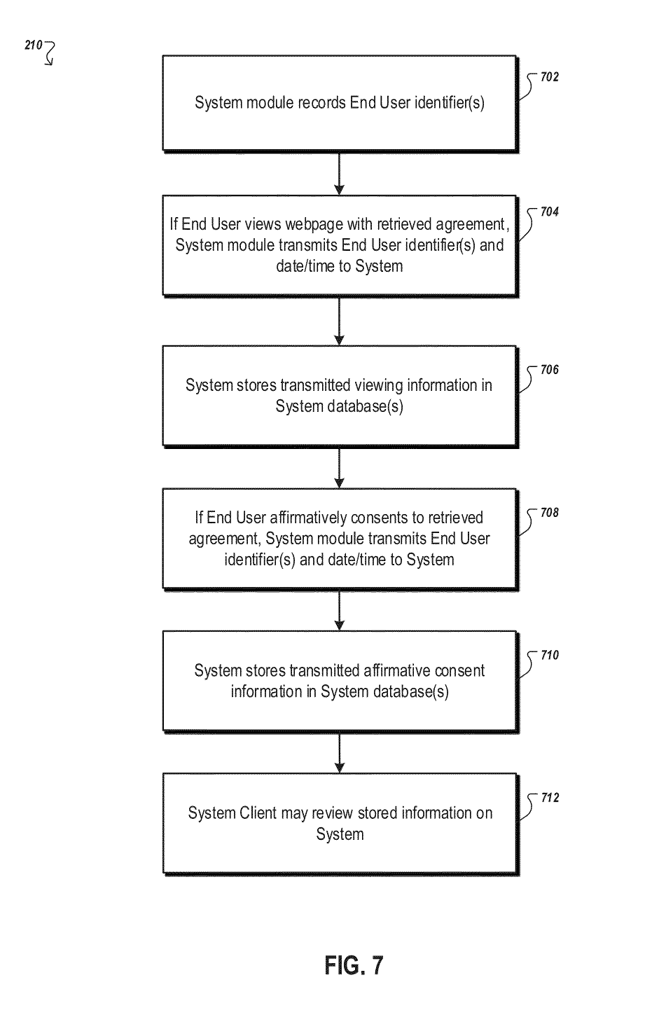

FIG. 7 describes the subparts of the ‘Track End User's viewing/acceptance of agreement(s)’ 210 step, typically including the substeps of ‘System module records End User identifier(s)’ 702; ‘If End User views webpage with retrieved agreement, System module transmits End User identifier(s) and date/time to System’ 704; ‘System stores transmitted viewing information in System database(s)’ 706; ‘If End User affirmatively consents to retrieved agreement, System module transmits End User identifier(s) and date/time to System’ 708; ‘System stores transmitted affirmative consent information in System database(s)’ 710; and ‘System Client may review stored information on System’ 712.

The ‘System module records End User identifier(s)’ 702 step may typically be performed by a module and/or the system 130. Typically, end user identifier(s) may include, but is not limited to, elements such as date, time, end user's IP address (IPv4, IPv6, etc.), browser fingerprint (e.g, browser serial number, browser ID file, browser type, browser version, time zone, screen size, color depth, local code indicators, etc.), end user's geographic location (e.g., where end user allows location services on desktop or mobile device), etc.

In some implementations, the module may subsequently pass along collected end user identifier(s) to the system 130, which in turn records these end user identifier(s) in a database of the system 130 (described below in application). These end user identifier(s) may, for example, be used to tie a specific end user to an agreement if the need ever arose to enforce a client agreement to which that the end user denies consenting. Increasing end user identification factors may allow greater likelihood of proving an end user's identity beyond the inherent issues of proving an end user's identity based solely on the end user's IP address.

The ‘If End User views webpage with retrieved agreement, System module transmits End User identifier(s) and date/time to System’ 704 and the ‘If End User affirmatively consents to retrieved agreement, System module transmits End User identifier(s) and date/time to System’ 708 steps may typically be performed by a module and/or a client server. Typically, end user identifier(s) may include, but is not limited to, elements such as date, time, end user's IP address (IPv4, IPv6, etc.), browser fingerprint, browser type, browser version, end user's geographic location (e.g., where end user allows location services on desktop or mobile device), etc.

The ‘System stores transmitted viewing information in System database(s)’ 706 and the ‘System stores transmitted affirmative consent information in System database(s)’ 710 steps may typically be performed by the system 130. Typically, a module (e.g., system module x 110, etc.) or a client-side application may transmit an end user's identifier(s) when the end user navigates to a webpage on the client website 104 and is presented with a retrieved agreement. If the end user has only viewed a populated client agreement (as in step 708), then the system 130 stores in a database a value representing a positive viewing, the end user's identifier(s), and the current date and time at viewing the client agreement. The stored value representing a positive viewing may be used to demonstrate that a particular end user viewed and had knowledge of a client agreement revision at a particular time and date. In some implementations, the stored value may also be used calculate the total number of times an client agreement revision has been viewed by a same end user, a similar subset of end users, or all end users.

If the end user additionally gives affirmative consent to the client agreement (as in step 710), then the system 130 stores in a database a value representing affirmative consent, the end user's identifier(s), and the current date and time at affirmatively consenting to the client agreement. The stored value representing affirmative consent may be used to demonstrate that a particular end user had knowledge of and agreed to a client agreement revision at a particular time and date. Further, in some implementations the stored value may also be used calculate the total number of times an client agreement revision has been affirmatively consented to by a same end user, a similar subset of end users, or all end users. Further, in some implementations, association with the above-described viewing or affirmative consent values the end user identifier(s) may allow a client or the system 130 to perform searching, tracking, and/or analysis of the stored data.

The ‘System Client may review stored information on System’ 712 step may typically be performed by a client. Typically, a client may review stored information on the system 130 by browsing to a statistical viewer (e.g., agreement statistics viewer 1300, described later in this application) or connecting to the system 130 through a client-side statistical viewer. The client may, for example, review all client agreement revisions or look specifically at a subset of the client agreement revisions. For example, a client may wish to check what percentage of end users view the client website 104's client agreements but never affirmatively consent to the client agreements.

Additionally, a client may wish to check whether a new revision of a website client agreement has resulted in a substantial decrease in affirmative consent compared to previous revisions. This may be, for example, to review how different revision modifications affect end users' trust and/or apathy of the client's client agreements.

In some implementations of the system 130, the system 130 may automatically notify a client based on default or manually set statistical threshold. For example, a client may set the system 130 to notify the client if a new revision results in more than a twenty-percent decrease in end user affirmative consent relative to previous revision statistics.

In other implementations, automated reports may be sent to clients detailing client agreement statistics over a period of time. For example, a client may receive weekly summaries of the week's views and affirmative consents, the ratio of affirmative consents compared to the week's views, and an ongoing summary of the annual statistics thus far.

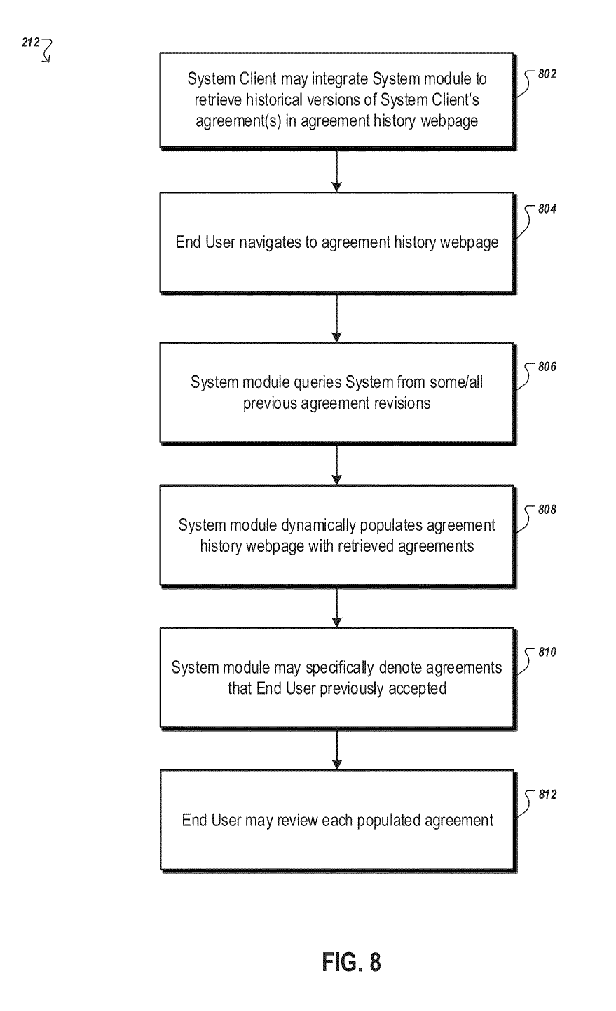

FIG. 8 describes the subparts of the ‘End User may review agreement history’ 212 step, typically including the substeps of ‘System Client may integrate System module to retrieve historical versions of System Client's agreement(s) in agreement history webpage’ 802; ‘End User navigates to agreement history webpage’ 804; ‘System module queries System from some/all previous agreement revisions’ 806; ‘System module dynamically populates agreement history webpage with retrieved agreements’ 808; ‘System module may specifically denote agreements that End User previously accepted’ 810; and ‘End User may review each populated agreement’ 812.

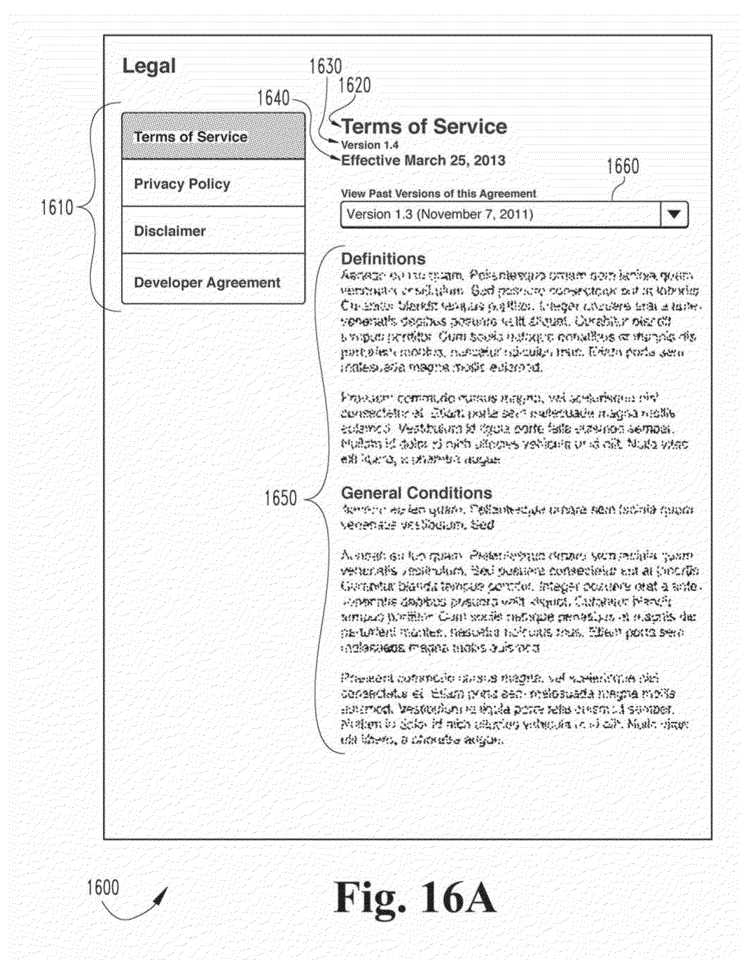

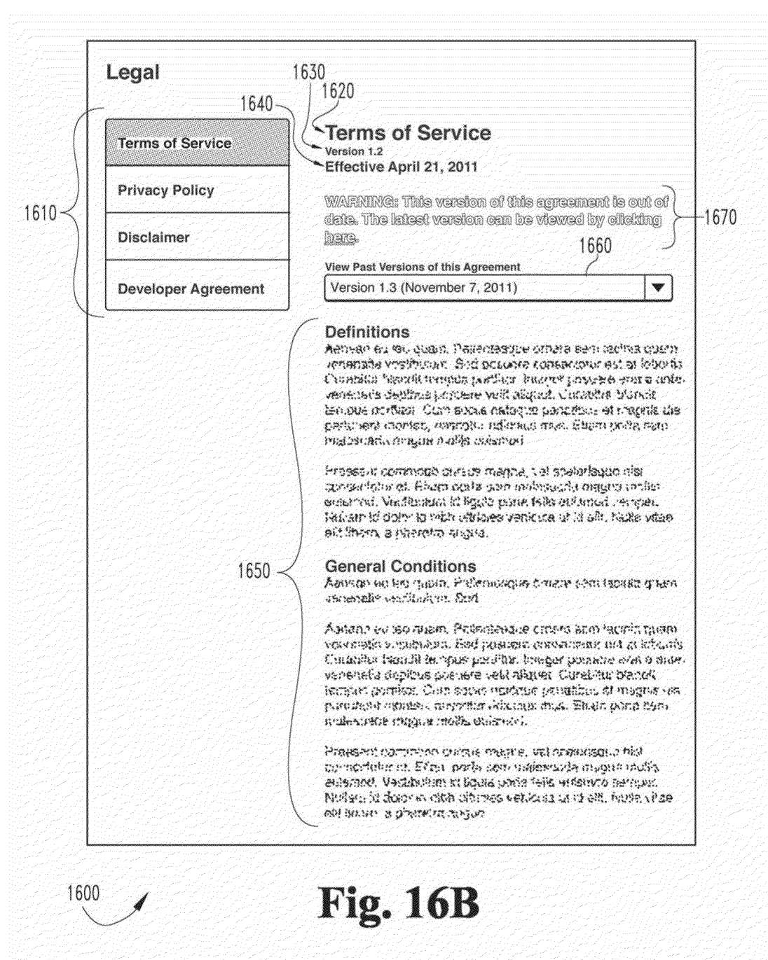

The ‘System Client may integrate System module to retrieve historical versions of System Client's agreement(s) in agreement history webpage’ 802 step may typically be performed by the client. Typically, a client may create a webpage to allow an end user to browse all historical revisions of the client agreement(s). The webpage may be created through any known programming methods (e.g., HTML, CSS, PHP, JAVASCRIPT, etc.). An example of one form of an agreement history webpage 1600 is displayed in FIGS. 16A-16B (described in detail later in the application). The client then integrates a module to dynamically interface with the system 130 and retrieve the client agreement(s). For example, the client may add a client-side module using HTML, PHP, JAVASCRIPT, or any other mechanism for interfacing between the client's website 104 and the system 130 servers. In some implementations, the provider of the system 130 may supply the client-side software for integration, while in other implementations the client may provide their own software for integration. Typically, communication from the integrated component to the system 130 is accomplished through an application programming interface (API).

Further, the ‘End User navigates to agreement history webpage’ 804 step may typically be performed by an end user. Navigation may be accomplished, for example but not limited to, by entering a webpage address into an Internet browser, clicking on a hypertext link to the webpage, and/or clicking on an icon or image linking to the webpage.

Additionally, the ‘System module queries System from some/all previous agreement revisions’ 806 step may typically be performed by a module after the end user has navigated to the agreement history webpage 1600. The module (e.g., the historical module 109, etc.) may then query the system 130 for every revision of a particular agreement (e.g., Terms of Service) associated with the client's website 104; for a subset of every revision of a particular client agreement associated with the client's website 104 (e.g., only the last five revisions of Terms of Service); and/or for every revision of every client agreement associated with the client's website 104. In another implementation, the module (e.g., the historical module 109) may only query the list of client agreements associated with the client website 104, whereas in other implementations the module may query for the list of client agreements and/or the text of those client agreements.

In some implementations, the module (e.g., the historical module, etc.) may query the system 130 automatically when an end user navigates to the agreement history webpage 1600, while in other implementations the module may query the system 130 only after the end user commits some interaction with the agreement history webpage 1600. For example, the module may query the system 130 only after end user clicks on a particular client agreement (e.g., Terms of Service). Such an implementation may, for example, be implemented to reduce bandwidth usage and/or API calls to the system 130.

The ‘System module dynamically populates agreement history webpage with retrieved agreements’ 808 step may typically be performed by a module. Typically, the module receives the retrieved client agreements and/or client agreement information from the system 130 and then populates one or more fields on the agreement history webpage 1600 (e.g., agreement title 1620, agreement version 1630, agreement date 1640, retrieved revision text 1650, etc.). In some implementations, the module may populate all such fields at once or it may only populate a subset of the fields. In other implementations, the module may only populate such fields upon interaction from the end user (e.g., the end user clicks on a specific agreement revision). Further, in some implementations, the module may only request client agreement text after an end user has selected a revision from a retrieved listing, while in other implementations, the module may request and cache every client agreement revision and all revision text for more immediate recall with fewer discrete API calls to the system.

Some implementations of the agreement history webpage 1600 may also implement a differential view of the client agreement revisions to more easily convey differences between client agreement revisions to end users. For example, the revision may be presented as a redline-view document (wherein, for example, underlines represent additions to a client agreement and strikethroughs represent deletions). In other implementations, the module and/or agreement history webpage 1600 may provide alternative differential views to compare client agreement revisions (e.g., time interchange images or mouseover implementation).

In yet another implementation, the module may retrieve differential records from the system 130 that represent only the differences between revisions. For example, the system 130 may save only an additional clause or paragraph, and/or it may save an expression of the deletion of a clause or paragraph. This may be implemented, for example, to save space or reduce bandwidth usage.

The ‘System module may specifically denote agreements that End User previously accepted’ 810 step may typically be performed by the module (e.g., the historical module 109) on the agreement history webpage 1600. Typically, if the system 130 may recognize the end user requesting the agreement history webpage 1600, the system 130 may also transmit to the module any client agreement revisions to which that particular end user affirmatively consented. For example, if the end user is logged into the client's website 104, the module may transmit the end user's username to the system 130; the system may retrieve all previously stored values machine that username's “view” or “affirmative consent” values; and the system 130 may then transmit those corresponding revision matches to the module. In some implementations, the module may denote on the agreement history webpage 1600 which revisions an end user has viewed and/or affirmatively consented to (e.g., in a list or on each individual revision webpage).

The ‘End User may review each populated agreement’ 812 step may typically be performed by the end user after the module has populated some or all revisions of the client agreement history webpage 1600. Typically, the end user may be presented with a list of client agreement revisions to select (e.g., using an agreement selector 1610), and the module (e.g., the historical module 109, system module x 110, etc.) or client webpage may populate the agreement history webpage 1600 with the client agreement revision text. For example, an end user may wish to view the first Terms of Service published by the client website 104 and would do so by selecting that revision from the list of client agreement revisions. In some implementations, the agreement history webpage 1600 may automatically display the current revision of the client website's agreement(s). As described above, differential views of the revisions may allow an end user to more easily see changes between client agreement revisions.

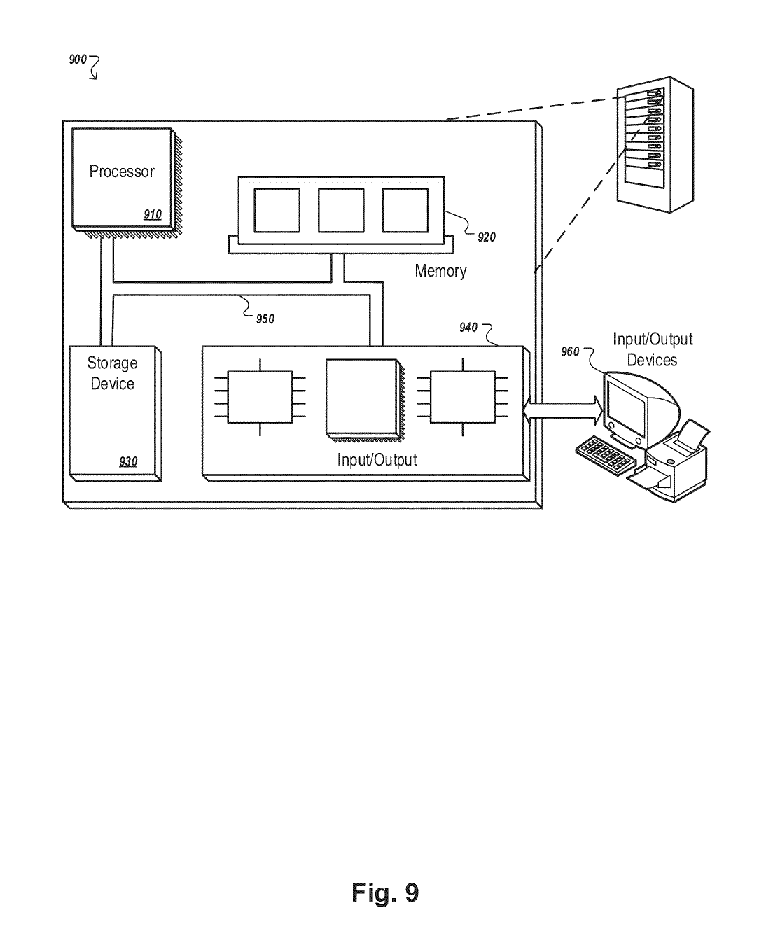

FIG. 9 is a block diagram of an example computer system 900 that may be used to implement the electronically securable agreement management system 130. The system 900 includes a processor 910, a memory 920, a storage device 930, and an input/output device 940. Each of the components 910, 920, 930, and 940 may be interconnected, for example, using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 may include, for example, a hard disk device, an optical disk device, or some other large capacity storage device.

The input/output device 940 provides input/output operations for the system 900. In one implementation, the input/output device 940 may include one or more of a network interface devices, e.g., an Ethernet card, a serial communication device, e.g., and RS-232 port, and/or a wireless interface device, e.g., and 802.11 card. In another implementation, the input/output device may include driver devices configured to receive input data and send output data to other input/output devices, e.g., keyboard, printer, and display devices 960. Other implementations, however, may also be used, such as mobile computing devices, mobile communication devices, set-top box television client devices, etc.

Although an example processing system has been described in FIG. 9, implementations of the subject matter and the functional operations described in this specification may be implemented in other types of digital electronic circuitry, or in computer software, firmware, or hardware, including the structures disclosed in this specification and their structural equivalents, or in combinations of one or more of them.

Embodiments of the subject matter and the operations described in this specification may be implemented as a method, in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer program instructions, encoded on computer storage medium for execution by, or to control the operation of, data processing apparatus. Alternatively or in addition, the program instructions may be encoded on an artificially-generated propagated signal, e.g., a machine-generated electrical, optical, or electromagnetic signal, that is generated to encode information for transmission to suitable receiver apparatus for execution by a data processing apparatus.

A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate physical components or media (e.g., multiple CDs, disks, or other storage devices).

The operations described in this specification may be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (application-specific integrated circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing, and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described in this specification may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser. Embodiments of the subject matter described in this specification may be implemented in a computing system that includes a back-end component, e.g., as a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) may be received from the client device at the server.

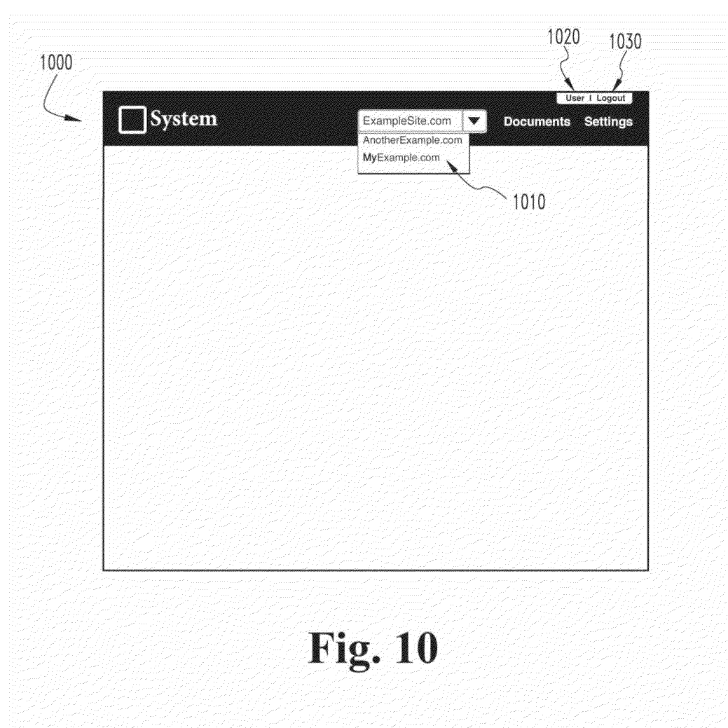

FIGS. 10-16B illustrate implementations of the electronically securable agreement management system 130 to create, modify, and publish end user agreements; view and track end user viewing and agreement to specific agreement revisions; and integrate the electronically securable agreement management system 130 into client websites 104.

FIG. 10 depicts an implementation of the an interface on the electronically securable agreement management system 130 to select an associated client website 104 for management, typically including a website selection portion of the system interface 1000; a website selector 1010; a user account link 1020, and a logout link 1030. The website selection portion of the system interface 1000 typically resides at the top of the interface display of the system 130; however, the website selection portion of the system interface 1000 may just as easily be placed anywhere else on the interface display. The website selector 1010 is depicted in FIG. 10 as a dropdown menu with three listed client websites 104; however, the website selector 1010 may also be in table form on the interface, a radio-button listing, or any other selection methods. Further, a nigh-infinite number of client websites 104 may be associated with a client and displayed in the website selector 1010, and in some implementations, an additional parsing method (e.g., a scroll bar, a search box, etc.) may be integrated into the website selector 1010 for larger lists of associated client websites 104.

Additionally, while the user account link 1020 and the logout link 1030 are depicted at the top-right of the interface, they too may be located anywhere else on the interface. Typically, clicking on the user account link 1020 may navigate the browser to a listing of the end user's current user settings including, but not limited to, the end user's email, account password, billing information, current subscription status, previous billing statements, etc. In some implementations, clicking on the user account link 1020 may also allow the end user to modify the user settings (i.e., updating password, changing billing address, updating credit card, etc.). Similarly, when an end user clicks on the logout link 1030 a logout action is performed by the system 130 and the end user typically is navigated to a logout confirmation screen and/or back to a login screen for the system 130.

FIGS. 11A-11B illustrate one implementation of the system 130 in which a client may review existing agreements and draft new client agreements and client agreement revisions, typically including an agreement documents interface 1100.

FIG. 11A specifically depicts one implementation of the agreement documents interface 1100 displaying existing client agreements associated with “ExampleSite.com” selected in the website selector 1010 (e.g., Terms, Privacy, and Agreement); existing revisions of an Terms agreement, and the option to create a new draft revision of the Terms agreement. While the various components are depicted in fixed positions in FIG. 11A, other implementations may have altered or dynamically assigned positions.

FIG. 11B specifically depicts an implementation of the agreement documents interface 1100 displaying a new draft of a client agreement. Typically, the new client agreement draft is denoted by an overlay stating “DRAFT” or something of the like, as shown in FIG. 11B; however, in other implementations coloration, gradation, or other differentiation methods may be used to distinguish a draft client agreement from a published client agreement. In other implementations, there may be no distinction between a draft client agreement and a published client agreement.

Additionally, the agreement documents interface 1100 may also note properties of the draft. For example, agreement documents interface 1100 may list, but is not limited to, the version/revision of the agreement and the last time the draft was updated. An indicator may also be present to open the draft in an editor (as one such example, shown as a box labelled “Open” in FIG. 11B). In other implementations, clicking on an icon of the client agreement itself may navigate to an editor, and in some other implementations such an icon may be a preview of the client agreement's contents.

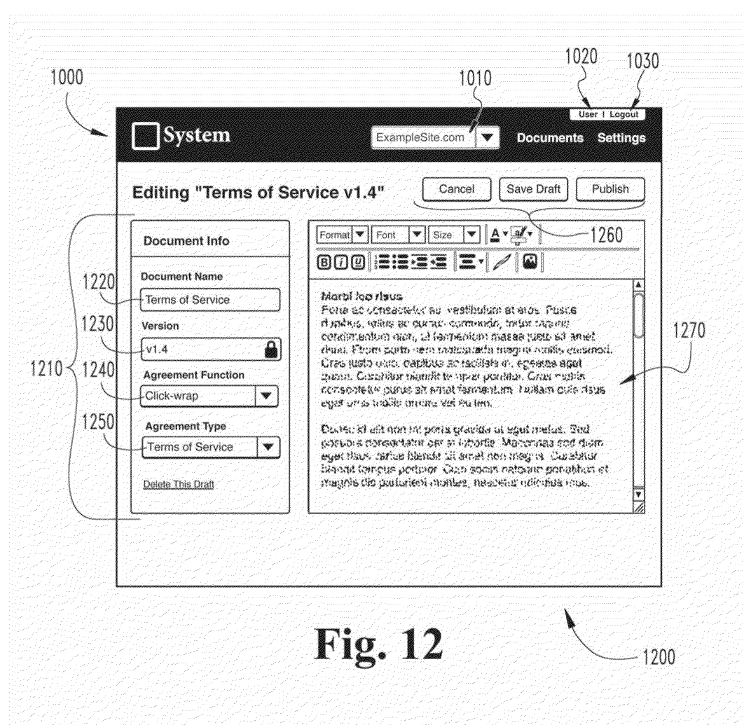

FIG. 12 depicts an implementation of the electronically securable agreement management system 130 containing an agreement editor interface, typically including an agreement editor interface 1200; document information prompts 1210; a document name prompt 1220; a document version prompt 1230 (document revision prompt); an agreement function selector 1240; an agreement type selector 1250; editor publication options 1260; and an editor window 1270.

Typically, the agreement editor interface 1200 contains subparts including, but not limited to, document information prompts 1210, editor publication options 1260, and an editor window 1270. The document information prompts 1210 list a variety of properties of the client agreement being edited that are embedded into the client agreement. For example, the document name prompt 1220 may be, but is not limited to, the client agreement type (where predefined), a unique string, or a client-defined string.

The document version prompt 1230 (document revision prompt) may be a fixed increment of the client agreement revision based upon previous revisions or the client may define increments to be used (e.g., 1.0, 2.0, etc.). In some implementations, the client may assign whatever value in the document version prompt 1230, so long as it does not conflict with a previous revision's value.

The agreement function selector 1240 may define whether the client agreement is treated as a clickwrap- or browsewrap-type client agreement and thus how the client agreement may be displayed on the client webpage. Typically, this may be automatically filled in with a value inherited from previous revisions of the client agreement. That is, if the Terms were initially or most recently defined as a clickwrap-type client agreement, the agreement function selector 1240 may automatically default to “Click-wrap”. In some other implementations, the field may default to no selection and require the client to select which client agreement function he or she wishes the revision to be. In a further implementation, the system 130 may set a universal default option.

The agreement type selector 1250 functions similar to the agreement function selector 1240, but the agreement type selector 1250 assigns the a default or client-set agreement format. For example, these may be common client agreement schemes (e.g., Terms of Service; Privacy Policy; End User License Agreement; etc.) or they may be agreements more specific to the client's website (e.g., Blog Privacy Policy; Forum Privacy Policy; etc.). In some implementations, creating a new agreement type may also display this agreement type in the “Documents” section shown in FIGS. 11A-11B.

The editor publication options 1260 section contains one or more options pertaining to the present status of the draft. For example, the editor publication options 1260 may include, but are not limited to, “Cancel,” “Save Draft,” “Publish,” “Revert,” and/or “Highlight Changes.” Each option may in turn perform an action, such as cancelling and exiting the agreement editor interface 1200, setting the draft as the current client agreement revision (e.g., the “Publish” option), or saving the draft text but not marking the revision as the current revision. In some implementations, selecting the options may bring up submenus as well. For example, clicking “Publish” might bring up a scheduler to set whether to publish the revision immediately or to set it to be published as the current revision at a future time/date.

In some other implementations, a client may set the system 130 to email all end-users associated with the previous client agreement revision(s) immediately or at some future point in time. In another example, such an emailing feature may also be triggered automatically upon publication of any new revisions by a client.

The editor window 1270 typically occupies a majority of the agreement editor interface 1200; however, it may be made to take up a smaller space as well. For example, if the agreement editor interface 1200 accessed through a client's mobile device (which likely has a smaller screen), the editor interface 1200 may collapse various elements or be presented through a multistage process (e.g., the document information prompts 1210 presented first; the editor window presented second; and the editor publication options presented last).

In some implementations, the editor window 1270 is a simple, plain-text input, whereas in other implementations, the editor window 1270 may have formatting and style options (e.g., typeface, font size, position, etc.). Other implementations may also have preset format schemes to import and/or multimedia input (e.g., adding a picture or logo into the agreement).

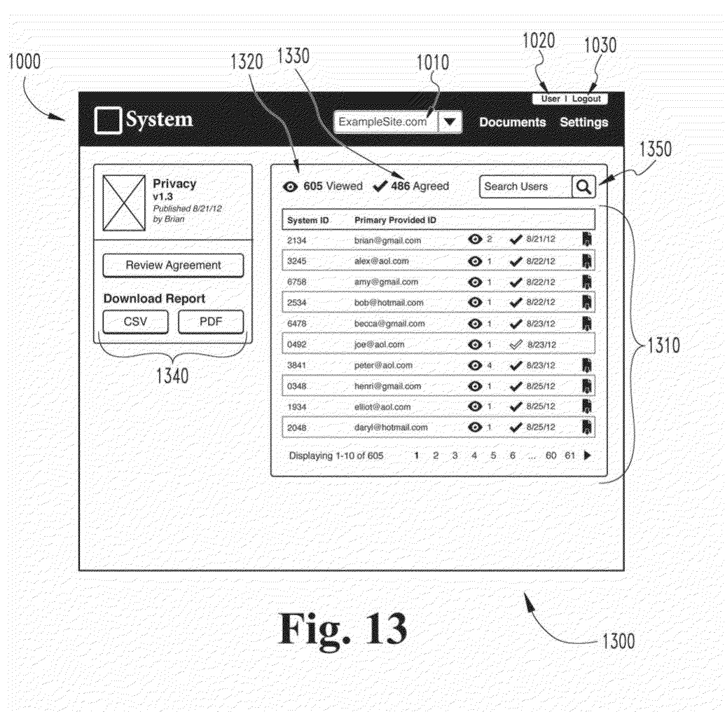

FIG. 13 depicts an implementation of statistical tracking of an client agreement on the electronically securable agreement management system 130, typically including an agreement statistics viewer 1300; user statistic listings 1310; an affirmative view counter 1320; an affirmative response counter 1330; and statistical report export options 1340. The agreement statistics viewer 1300 typically may be accessed by selecting an agreement revision from an interface of the system 130 (e.g., the agreement documents interface 1100) and may typically be used in conjunction with the statistical module 108 to enable functions on the system 130 or at the client-side (e.g., the client using a software application to interface with the system 130 and/or agreement database 132). Optionally, the system 130 may save data on each transaction and/or all aggregate transactions. For example, the system 130 may save data to the agreement database 132 and/or any other database.

The agreement statistics viewer 1300 may allow clients to view individual end user information with respect to the selected client agreement revision. For example, the user statistic listing 1310 may include a unique System ID assigned to the end user, the end user's email address, and when the end user has viewed or consented to the revision. In some implementations, the user statistic listing 1310 may also show how many times an end user has viewed or consented to the revision. In other implementations, clicking on a particular end user in the user statistic listing 1310 may display additional information concerning the end user (e.g., browser used, IP address, real name, etc.). In other implementations of the agreement statistics viewer 1300, total views and/or affirmative consents to an agreement revision may be tallied and displayed, such as through the affirmative view counter 1320 and/or the affirmative response counter 1330.

Further, some implementations of the agreement statistics viewer 1300 may include statistical report export options 1340. For example, a client may download an exported report formatted in a commonly used document format (e.g., CSV, PDF, etc.). The exported report may include, but is not limited to, information regarding end users' viewing and affirmative consent over time, activity sorted by end user, activity sorted chronologically, etc. In some other implementations, the client may be able to set up a periodic export of a report delivered to the client. For example, the client may set up an export function to occur every week showing the total views and/or affirmative consents over the past week. Some implementations may also include per end user report downloads, which may be located, for example, on the user statistic listing.

In some implementations, the agreement statistics viewer 1300 may also include a search function. For example, a statistical search field 1350 may be used to search for a specific end user, system ID, email address, or any other property or value stored on the system 130. The statistical search field 1350 may operate in conjunction with, or separate from, the search system 112, the search index 114, and/or the indexed resources depicted in FIG. 1.

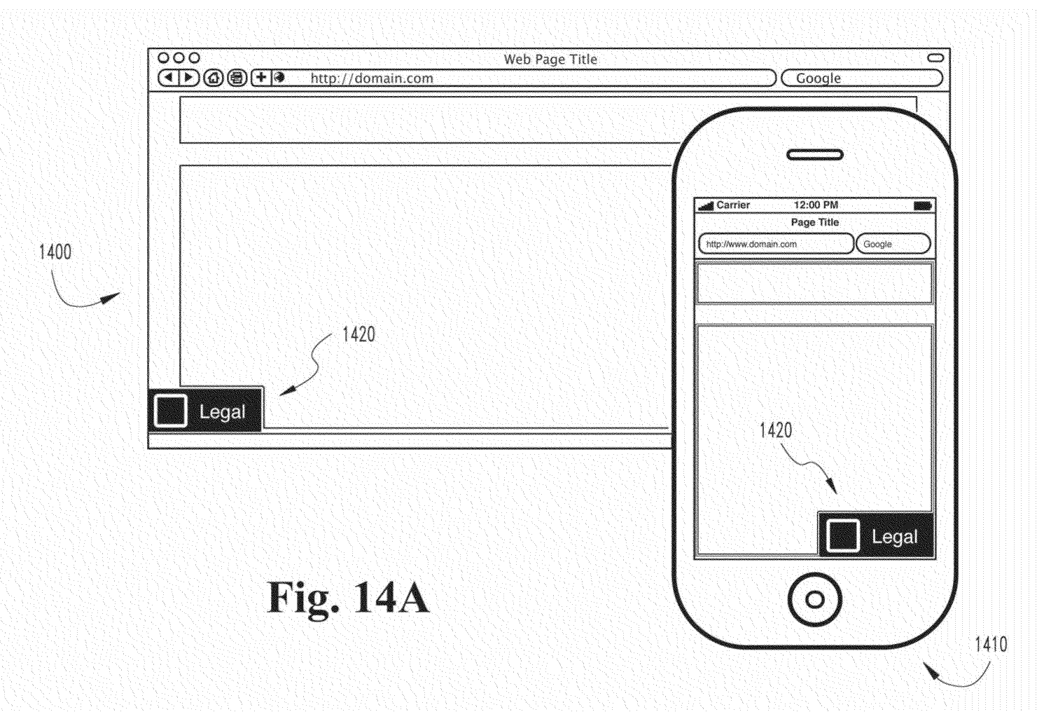

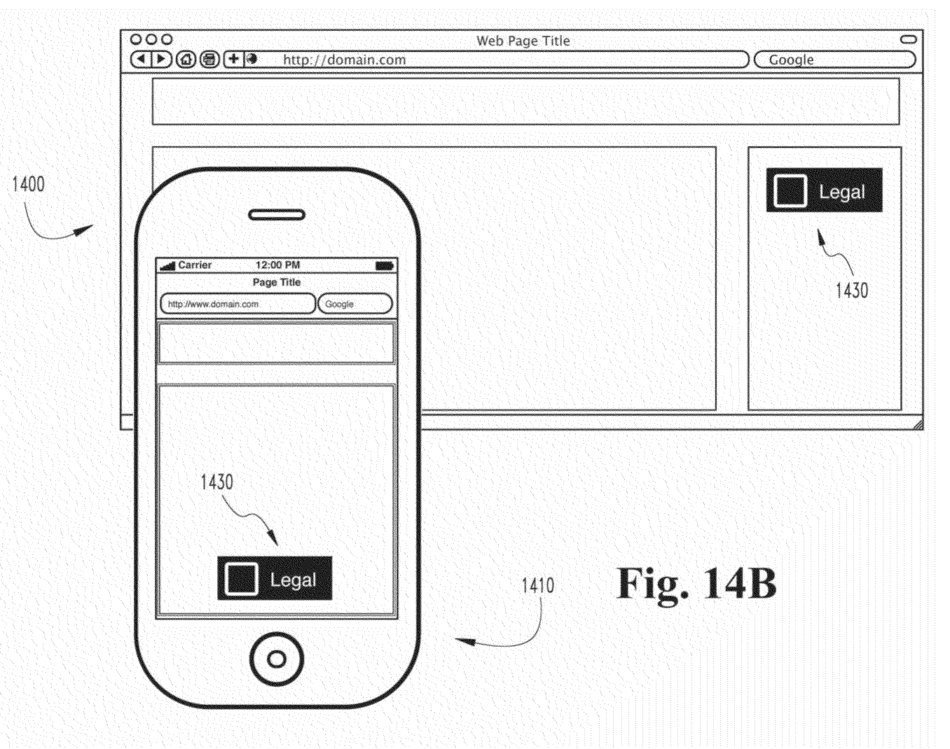

FIGS. 14A-14B illustrate implementations of system badges that provide constructive notice to website end users of legal terms and conditions, typically including a desktop display 1400; a mobile display 1410; a fixed badge 1420; and an inline badge 1430. Constructive notice signifies that a person and/or entity should have knowledge of a circumstance, as a reasonable person would have, even if the person and/or entity had no actual knowledge of the circumstance. For example, a buyer of a parcel of land is presumed to have knowledge of the legal status of the parcel because the buyer could have viewed the parcel's legal status in public records. Similarly, a visible badge on the client website 104 denoting legal terms acts to inform an end user of a client website 104 that the end user may be subject to those legal terms, providing the end user with constructive notice of the contents of the client website 104's legal terms.

Typically, badges generated on a client website 104 may be data displayed on a client website 104 to an end user through end user devices 106. For example, a badge may be data represented as a small, blue rectangle on the lower portion of an end user device 106 display. In other implementations, a badge may be data represented as a red banner generated across one or more borders of the end user device 106 display. Badges may typically be desirable in conjunction with browsewrap-type agreements; however, they could also be used with clickwrap-type client agreements as well. Additionally, badges may be linked to a webpage displaying the legal terms and conditions of the client's website, but it need not necessarily be so linked. In some implementations, the provider of the system 130 may be depicted in text or symbolically as a common, trustworthy source of legal agreement management.

FIG. 14A specifically depicts a fixed-orientation badge that provides constructive notice to website users of legal terms and conditions via the electronically securable agreement management system 130. As the end user browses a client's website, the fixed badge 1420 may appear in a static position of the desktop display 1400 or the mobile display 1410, regardless of the end user's activity on the client's website. The fixed badge 1420 position is depicted as the bottom corners of the displays, but the fixed badge 1420 may be positioned anywhere on the displays as is desired. In some implementations, the fixed badge 1420 may be dismissible by the end user after the end user affirmatively consents to some sort of client agreement on the client's website (e.g., if the client website 104 also implements a clickwrap-type client agreement when creating a user account).

FIG. 14B specifically depicts an inline-orientation badge 1430 that provides constructive notice to website users of legal terms and conditions via the electronically securable agreement management system 130. As the end user browses a client's website, the inline badge 1430 may appear in an inline position of the client's website as opposed to a fixed position of the desktop display 1400 or the mobile display 1410. Thus, an end user's activity on the client's website may cause the end user to see either the inline badge 1430 or not depending on what portion of the client's webpages is being viewed by the end user. Like the fixed badge 1420, the inline badge 1430 may be positioned anywhere on the client's webpage. In some implementations, the inline badge 1420 also may be dismissible by the end user after the end user affirmatively consents to some sort of client agreement on the client's website (e.g., if the client website 104 also implements a clickwrap-type client agreement when creating a user account).

FIGS. 15A-15D illustrate various stages of an end user signup process on an example end user signup webpage 1500 integrating agreement retrieval from the system 130, typically including a end user signup webpage 1500; client-defined information fields 1510; an agreement population field 1520; a signup button 1530; an agreement button 1535; affirmative consent selectors 1540; and agreement export options 1550.

FIG. 15A specifically depicts an example end user signup webpage 1500 that integrates client agreement retrieval from the electronically securable agreement management system 130. On the end user signup webpage 1500, the client may provide client-defined information fields 1510 for collecting information about the end user. For example, the client-defined information fields 1510 may include, but are not limited to, the end user's name, email, desired password, country, age, etc. In some implementations, some of these client-defined information fields 1510 may be used to screen end users. For example, a client may wish to cater solely to individuals located in the United States who are above the age of thirteen. Alternatively, other client's may wish to exclude anyone who is not above the age of eighteen. If the end-user does not meet the desired thresholds, the client webpage deny advancement of the end user signup webpage 1500 and/or may notify the end-user of the threshold requirements.

Additionally, end user signup webpage 1500 typically contains an agreement population field 1520. This agreement population field 1520 typically may interface with the system 130 through a module (e.g., system module x 110, etc.) and/or a client-side application to query and retrieve the most recent client agreement(s) from the system 130 associated with the client's website. In some implementations, the retrieved client agreement(s) may be populated in a fixed-size container field on the webpage, and an end user may scroll through the client agreement(s) if the text of the client agreement extends beyond the fixed size. In other implementations, the container may dynamically resize to accommodate the size of the client agreement. For example, if the text of the client agreement(s) is shorter than the default container size, the container may contract to fit the text, and if the text of the client agreement(s) is longer than the default container size, the container may expand to fit the text.

A signup button 1530 is also generated to complete the signup process by the end user; however, it is typically disabled until sufficient affirmative consent is received from the end user. In some implementations, the signup button 1530 may not be generated until such conditions are met, while in other implementations it may be inactive until such conditions are met.

FIG. 15B specifically depicts an example end user signup webpage 1500 after client agreement(s) retrieval from the electronically securable agreement management system 130 but before affirmative consent from a user. Example end user inputs have been supplied to the client-defined information fields 1510 and the agreement population field 1520 has been populated with two agreements. Each client agreement has been confined to a separate, fixed-size container with an associated scroll bar. The agreement population field 1520 has also been populated with affirmative consent selectors 1540 and agreement export options 1550. The signup button 1530 has not been generated yet, but an agreement button 1535 has been generated. However, the agreement button 1535 is displayed as inactive because the end user has not provided sufficient affirmative consent via the affirmative consent selectors 1540.

In some implementations, the module may create one or more affirmative consent selectors 1540 (as seen in FIGS. 15B-15C) adjacent to retrieved client agreement(s). Affirmative consent selector 1540 may typically be in the form of a checkbox but may also be in any other format to indicate a selection (e.g., a input requiring an end user to type “I agree” or a dropdown to select either “I agree” or “I disagree”).

Typically, where only one client agreement may be populated, only one affirmative consent selector 1540 may be displayed. However, in other implementations wherein the system module retrieves multiple client agreements, the module may generate multiple affirmative consent selectors 1540. For example, if two client agreements are populated (as shown in FIGS. 15B-15C), two corresponding affirmative consent selectors 1540 are generated. Generated affirmative consent selectors 1540 may appear below associated client agreements (as shown in FIGS. 15B-15C) or may be displayed anywhere else on the end user signup webpage 1500. Further, in some implementations, generated affirmative consent selectors 1540 may be dynamically named according to the associated agreement (e.g., may say, “I accept the Privacy Policy” in association with the populated Privacy Policy).

Sets of agreement export options 1550, specifically a print option and a download option, may also be generated adjacent to each populated client agreement. However, the agreement export options 1550 are not limited to printing and downloading. Additional options may include emailing, sending via SMS, or any other method of export. Such options may, for example, allow an end user to save the client agreements for their own records.

FIG. 15C specifically depicts an example end user signup webpage 1500 after initial affirmative consent from an end user. The end user has provided sufficient affirmative consent via the affirmative consent selectors 1540 as depicted by the checked boxes of FIG. 15C. Due to the end user's provision of sufficient affirmative consent, the agreement button 1535 has activated so that an end user may advance the process by selecting the agreement button 1535. In some implementations, selecting the active agreement button 1535 finalizes the end user signup process on the end user signup webpage 1500, whereas in other implementations the end user signup webpage 1500 requires further end user interaction to proceed.

Finally, FIG. 15D specifically depicts an example end user signup webpage 1500 after terminal affirmative consent is given (by clicking on the agreement button 1535), resulting in the collapsing of the two populated client agreement and allowing signup process to proceed. In some implementations, the populated client agreements need not collapse. An active signup button 1530 has now appeared, and typically, the end user's selection of the active signup button 1530 may finalize the end user signup process on the end user signup webpage 1500. In some implementations, further end user confirmation may be required for end user account activation. For example, an email may be sent to the end user's provided email address, requiring the end user to follow a final account activation hyperlink.

FIGS. 16A-16B illustrate two implementations of webpage for an end user to dynamically retrieve and view historical revisions of client agreement(s), typically including a client historical agreement webpage 1600; an agreement selector 1610; an agreement title 1620; an agreement version 1630 (agreement revision); an agreement date (version date; revision date) 1640; retrieved revision text 1650; a revision selector 1660; and a deprecation warning 1970. Typically, as discussed above with respect to FIG. 8, a client creates a historical agreement webpage 1600 and integrates a module (e.g., the historical module 109, etc.) to query and retrieve client agreement information associated with the client's website.

FIG. 16A specifically depicts an example client historical agreement webpage dynamically retrieving historical client agreements from the electronically securable agreement management system. The client historical agreement website 1600 may list all retrieved agreement types in an agreement selector 1610 and populate details from specific agreement revisions for the end user to view. For example, the populated details may include, but are not limited to, the agreement title 1620; the agreement version/revision 1630; the revision date 1640; and the retrieved revision text 1650.

In some implementations, for example where multiple revisions may be retrieved, the client historical agreement website 1600 may include a revision selector 1660. The revision selector 1660 is depicted as a dropdown list, but may be implemented as any method of selecting between the retrieved revisions.

In some implementations, the module and/or another module may also collect and send end user information/identifiers (e.g., the end user's username) to the system 130 to check if the end user consented to any previous client agreement revisions. If the system 130 returns matches to previous consent actions, the client historical agreement website 1600 may display an indication of prior consent to the end user. For example, the client historical agreement website 1600 may state, “You agreed to this revision on [DATE]”, where date is the stored consent date.

FIG. 16B specifically depicts an example client historical agreement webpage 1600 with a revision deprecation warning. Typically, when the module populates a revision that has an associated “deprecated [n]” value, the client historical agreement website 1600 may display a warning message informing the end user that the populated revision is not the current revision. The warning typically may be presented in an alternative typeface, size, color, or any other format that may draw attention to the warning, but need not necessarily be presented differently than the rest of the populated text. In some other implementations, the warning may also include a hyperlink to the current revision of the agreement that may allow the end user to navigate to the current client agreement revision.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for monitoring end-user viewing of agreements over a computer network, comprising the steps of:
providing an agreement management system;
allowing access to the agreement management system to a client and associating a website with the client in the agreement management system;
storing a client agreement in the agreement management system and associating the client agreement with the client in the agreement management system;
receiving and recording an end-user identifier in the agreement management system;
receiving and responding to an end-user query to view the client agreement;
storing the end-user query to view the client agreement and associating the end-user query with the end-user identifier; and
transmitting the client agreement to the end-user in response to the end-user query.

2. The method of claim 1, further comprising the steps of:
allowing access to the agreement management system; and
enabling a client to review data stored on the agreement management system selected from the group consisting of the end-user query to view the client agreement, the end-user identifier, and combinations thereof.

3. The method of claim 1, further comprising the steps of:
providing an agreement editor.

4. The method of claim 3, wherein the agreement editor may create further versions of the client agreement.

5. The method of claim 1, wherein:
the website comprises a plurality of websites;
the client agreement comprises a plurality of client agreements;
the end-user identifier comprises a plurality of end-user identifiers; and
the end-user query comprises a plurality of end-user queries.

6. A method for monitoring end-user affirmative consent to agreements over a computer network, comprising the steps of:
providing an agreement management system;
allowing access to the agreement management system to a client and associating a website with the client in the agreement management system;
storing a client agreement in the agreement management system and associating the client agreement with the client in the agreement management system;
receiving and recording an end-user identifier in the agreement management system;
receiving and responding to an end-user query to view the client agreement;
transmitting the client agreement to the end-user in response to the end-user query;
receiving and responding to an end-user query to affirmatively consent to the client agreement; and
storing the end-user query to affirmatively consent to the client agreement and associating the end-user query with the end-user identifier.

7. The method of claim 6, further comprising the steps of:
allowing access to the agreement management system; and
enabling a client to review data stored on the agreement management system selected from the group consisting of the end-user query to view the client agreement, the end-user query to affirmatively consent to the client agreement, the end-user identifier, and combinations thereof.

8. The method of claim 6, further comprising the steps of:
providing an agreement editor.

9. The method of claim 8, wherein the agreement editor may create further versions of the client agreement.

10. The method of claim 6, wherein:
the website comprises a plurality of websites;
the client agreement comprises a plurality of client agreements;
the end-user identifier comprises a plurality of end-user identifiers; and
the end-user query comprises a plurality of end-user queries.

11. A system for providing an automated clickwrap and browsewrap system configured to operate over a network using a server, a client with a client website, and a plurality of end-users associated with the client website, comprising:
a server operating the automated clickwrap and browsewrap system, the server adapted to communicate with a network;
a server-side module operating on the server;
wherein the module is configured to:
allow access to the automated clickwrap and browsewrap system to the client website;
associate the client website with the client in the automated clickwrap and browsewrap system;
store a client agreement in the automated clickwrap and browsewrap system;
associate the client agreement with the client in the automated clickwrap and browsewrap system;
receive and record an end-user identifier in the automated clickwrap and browsewrap system;
receive and respond to an end-user query;
store the end-user query and associate the end-user query with the end-user identifier; and
transmit the client agreement to the end-user in response to the end-user query.

12. The system of claim 11, wherein:
the client website comprises a plurality of client websites;
the client agreement comprises a plurality of client agreements;
the end-user identifier comprises a plurality of end-user identifiers; and
the end-user query comprises a plurality of end-user queries.

13. The system of claim 11, wherein a client-side module operating with the client website is responsive to the server-side module.

14. The system of claim 13, wherein the server-side module is responsive to a client query for historical data and populates data corresponding to a client historical webpage and transmits the data to the client.

15. The system of claim 13, wherein the server-side module is responsive to a client query for stored data and is configured to:
interface with the client website to transmit stored data selected from the group consisting of the client website, the client agreement, the end-user identifier, the end-user query, and combinations thereof; and
provide statistics to the client regarding the stored data.

16. The system of claim 15, wherein:
the client website comprises a plurality of client websites;
the client agreement comprises a plurality of client agreements;
the end-user identifier comprises a plurality of end-user identifiers; and
the end-user query comprises a plurality of end-user queries.

17. The system of claim 11, wherein the server operates the client website.
